(19) United States
(12) Patent Application Publication
(10) Pub. No.: US 2016/0291832 A1
(43) Pub. Date: Oct. 6, 2016

(54) METHOD AND PROGRAM FOR DISPLAYING INFORMATION

(71) Applicant: Web Service Development, Tokyo Ota District Nishi-Kamata (JP)

(72) Inventors: Kosei Ogawa, Tokyo (JP); Benjamin Maxwell Collins, Tokyo (JP)

(21) Appl. No.: 15/076,011

(22) Filed: Mar. 21, 2016

(30) Foreign Application Priority Data
Apr. 1, 2015 (JP) 2015-74765
Aug. 5, 2015 (JP) 2015-154916
Dec. 25, 2015 (JP) 2015-254551

(51) Int. Cl. G06F 3/0488; G06F 3/0485; G06F 3/0484; G06F 3/0482

(52) U.S. Cl. CPC G06F 3/0488; G06F 3/0482; G06F 3/0485; G06F 3/04842

(57) ABSTRACT

The present application involves an information display device for realizing a screen operation function of selecting any one of a plurality of items using a touch operation on a display screen. The touch operation on the display screen includes an operation panel display unit, a gesture detection unit and an operation determination unit. The operation panel display unit displays at least a first operation button, and a second operation button substantially surrounding an outer circumference of the first operation button on the display screen. The gesture detection unit detects a tap operation of touching of the first operation button and a swipe operation in a rotational direction along the second operation button. The operation determination unit performs candidate switching control for sequentially switching the item to be a selection candidate in accordance with a movement amount and a movement direction of the touch position.

### CLAIM OF PRIORITY

This application claims the benefit of Japanese Patent Application No. 2015-74765, filed 1 Apr. 2015; Japanese Patent Application No. 2015-154916, filed 5 Aug. 2015; and Japanese Patent Application No. 2015-254551, filed 25 Dec. 2015. The information contained therein is hereby incorporated by reference.

### BACKGROUND

1. Field of the Invention

The present application relates generally to devices that use a touch screen as a primary means of user interface are referred to as tablets and smart phones, and more particularly to a device that is able to use a finger or touch pen that when pressed against the device's screen which is able to track the user's touch location via hardware and transmit that data to a program running on the device which is able to interpret the user's touch movements as a gesture.

2. Description of Related Art

Two commonly known gestures used to navigate and select items on an electronic device are ‘tap’ and ‘swipe’. A ‘tap’ occurs when a user presses down on the screen in a fixed location and releases after a set period of time defined by the program. A ‘swipe’ gesture occurs when a user presses down in a location, moves their finger or touch pen while keeping it held down against the touch screen in a lateral direction before releasing.

Various ways and methods are commonly used. One method uses a user interface for a tablet or smart device containing a scrollable area with a list of selectable candidate items with a scroll bar to the right and two tabs on the top of the page. The user is able to scroll through the list by using vertical swipes up and down the page parallel to the direction of the scroll-bar. The thumb button on the scroll-bar moves up and down accordingly. The two tabs at the top of the page can be tapped to change the display of information inside the scrollable list.

The problem that arises with this arrangement is that the longer the scrollable list becomes; the more vertical swipes are required to scroll through the entire list. As this may become frustrating for longer lists, it is therefore desirable to have a touch interface operation that allows for simple traversal of long selectable lists on a tablet or smart phone.

Another common method uses a touch interface with two areas. A main display area where relevant information to the user is displayed and a navigation area with icons indicating content. A user is able to swipe left and right on top of the area containing icons to scroll through the list of icons. When the user performs a tap gesture on top of one of the icons, the main display area on the device changes to show relevant information pertaining to the indicated icon.

The problem to this implementation of a touch interface is similar to that of the prior method. As the list of icons becomes longer, the number of swipes required to traverse increases. Any frustration caused by the application may cause users to leave or abandon the use of the application if the user interface is too frustrating.

Another problem that indirectly occurs from the above mentioned methods occurs with the orientation of the device. Tablets and smart phones are often held with one hand in which the palm is used to support the device leaving only the thumb available for operation. Operations that require touch gestures in the center of the screen force users to adjust their hand so that their thumb can reach the center of the device, or use their free hand for operation. In their case, the operation of the touch interface can block the view of the person using it. The conclusion that can be drawn from this is that operations with a short area of range in one area of the device's screen that does not block the view of the screen during use is desirable.

Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a diagram of functions of an information display device according to the present application.

FIGS. 2-6 are a first exemplary representation of the information display device of FIG. 1.

FIGS. 7-9 are a second exemplary representation of the information display device of FIG. 1.

FIGS. 10-15 are a third exemplary representation of the information display device of FIG. 1.

FIGS. 16-21 are a fourth exemplary representation of the information display device of FIG. 1.

FIG. 22 is a flow chart diagram describing the details of behavior of the information display device according to the fourth embodiment of FIGS. 16-21.

FIG. 23 is a flow chart diagram describing the tapping operation process of the information display device of FIG. 1 according to a fifth embodiment.

FIG. 24 is an alternative flow chart diagram describing the long pressing operation process of the information display device of FIG. 1 according to the fifth embodiment.

FIG. 25 is an alternative flow chart diagram describing the swiping operation process of the information display device of FIG. 1 according to the fifth embodiment.

FIG. 26 is an alternative flow chart diagram describing the sliding operation process of the information display device of FIG. 1 according to a fifth embodiment.

FIGS. 27-28 are overview diagrams of a computer system implementing the information display device of FIG. 1 according to the first, the second, the third, the fourth and the fifth embodiments.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The embodiments will now be described with reference to the accompanying drawings, wherein like reference numerals designate corresponding or identical elements throughout the various drawings.

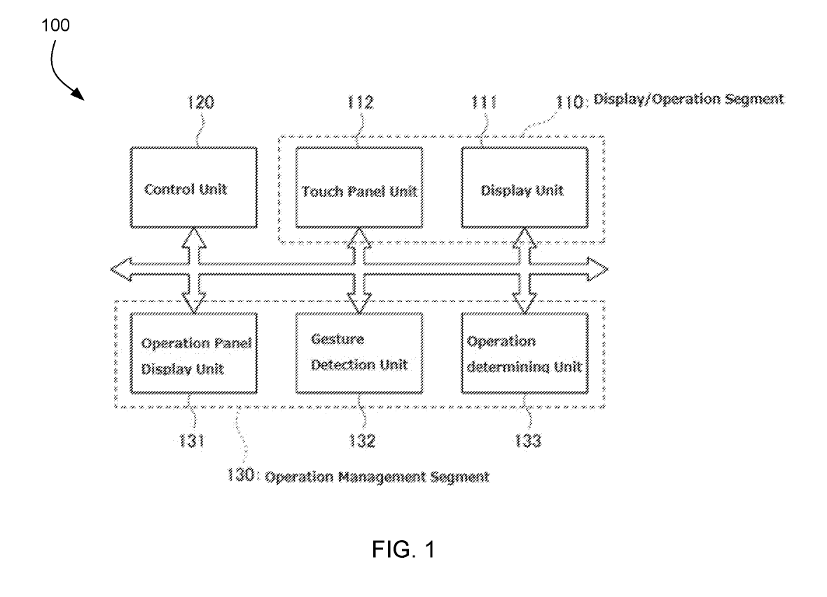

Referring now to FIG. 1 in the drawings, a diagram of functions of an information display device 100 are illustrated. Description of first embodiment of present invention

The description following is to exemplify certain preferred embodiments browsing operation of a corporate name list using information display device 100. information display device 100 may take numerous forms and types, such as a portable electronic device like a smartphone, tablet, laptop, watch, personal computer, and so on. For purposes herein, information display device will be shown as a tablet terminal. See FIG. 29 for more discussion related to the types and description of device 100.

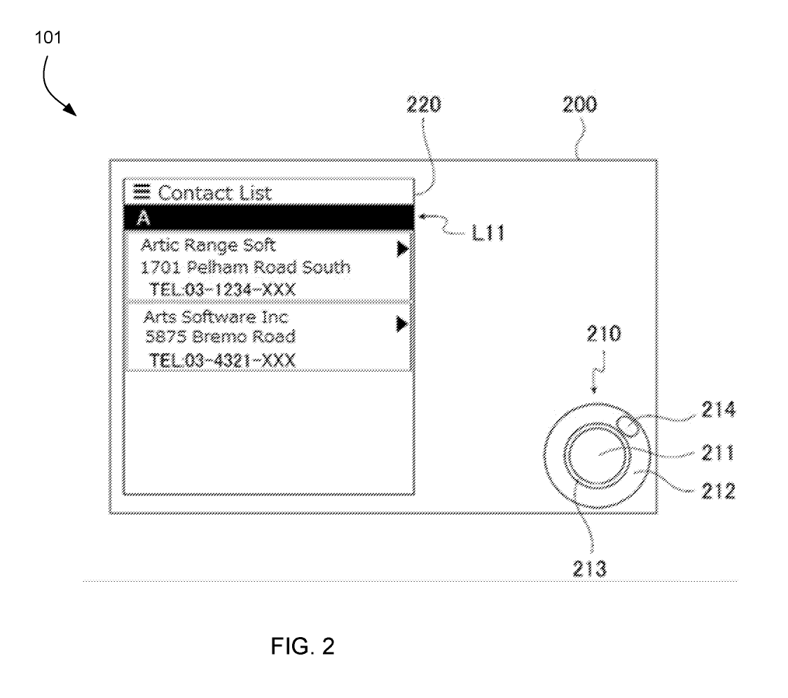

FIG. 1 is a block diagram of functions of tablet terminal 100 according to a first embodiment of the present invention. FIG. 2 is an example of a conceptual drawing of tablet terminal 100 according to a first embodiment of the present invention. Tablet 100 is an example of information display device 100 as described above.

As shown in FIG. 1, tablet terminal 100 includes display/operation segment 110, control segment 120, operation management segment 130. Display/operation segment 110 is the device for operator of tablet terminal 100 to blouse the display and operate it, and so on. This segment 110 includes display unit 111 and touch panel unit 112. Display unit 111 displays visual data sent from control segment 120. Touch panel unit 112 is layout on the display of display unit 111, output the coordinate, and other information of touching operation when it is touched by operator's finger or touching pen, or other touching devices. As for display/operation segment 110, normal touching display is applied for this purpose.

Control segment 120 controls displaying on the display unit 111, or the operational panel unit 210, performing various kinds of calculations, communication process using a certain communication circuit (no figure), according to the instruction signals input from control management segment 130. Control segment includes for example Central Processing Unit(CPU), semiconductor memory, Operating System(OS) and other software.

Operation management segment 130 generate various instruction signals according to the signals input from touching panel unit 112. For this purpose, operation management segment 130 includes operation panel display unit 131, gesture detection unit 132, operation determining unit 133. Operation management segment 130 can be composed by hardware components or by software components by executing a computer program (which corresponds to ‘operation program’ of presenting invention).

Referring now also to FIGS. 2-6 in the drawings, a first exemplary representation of information display device 100 is illustrated. Operation panel display unit 131 generates instruction signals for displaying operational panel 210. According to the instruction signals, control segment 120 displays operational panel 210 on the layer of display unit 111. This operational panel 210 is desirable to be displayed on the far right or far left so as the operator's thumb to be reached on the condition that the operator holds the tablet terminal 100 by hand.

The operation panel 210 has, for example, a round center button 211 (“corresponding to the first operation button” in the present invention). Further, the outer periphery of the center button 211 (corresponding to “second operation button” in the presenting invention) ring of the jog dial 212 are provided.

Here on the jog dial is an elliptical display area 214 which displays the position of a pointer or finger is provided. When the user of the jog dial swipes in the area inside the jog dial 212, the position of the jog dial display 214 moves accordingly inside jog dial area 212. It is preferable that the size of the display area 214 be large enough such that the view is not obstructed from the user by a single finger. The shape of the display area 214 is not limited to a circle and can also include such shapes such as a rounded rectangle. If a swipe takes place outside of the jog dial area 212, the jog dial display 214 will not move. It is also possible to hide the jog dial display area 214, or continue to enable the display. Such as the case where a finger swipe takes place outside the jog dial area 212 to hide the jog dial display area 214, continuing to display it is also an option. The operation is generally performed by a finger, but can be done with any pointing device such as a touch pen. Displaying the jog dial display area 214 inside the jog dial area 212 facilitates swipe operations.

When the jog dial display 214 is visible to the user, the operation management unit 130 searches for whether swipes take place inside or outside of jog dial region 212. In the case the swipe did indeed take place inside the jog dial region 212, the manager moves the jog dial display 214 to the corresponding user input location on the touch panel display 131. The functionality provided is such that the jog dial display 214 is redrawn at the location of a swipe or press where the user has indicated inside the jog dial region 212, such to show the input of the user.

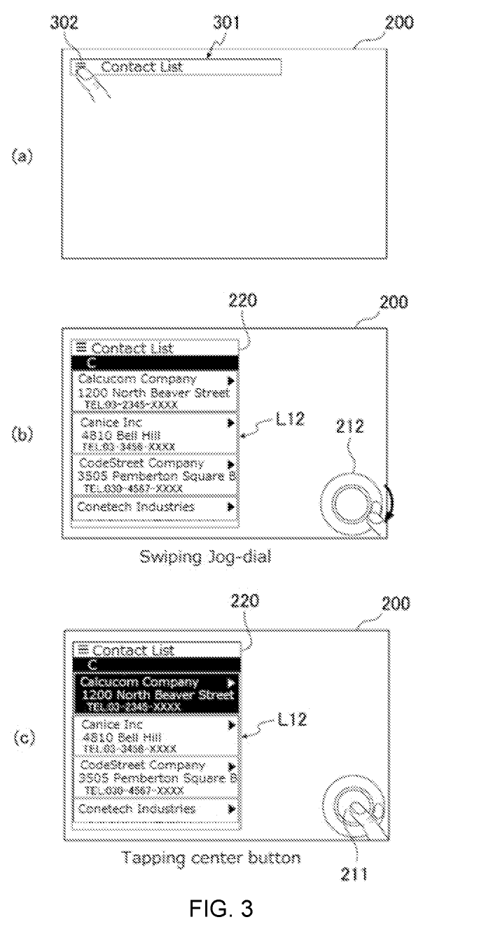

In addition, as illustrated in FIG. 3(b), it is preferable that the display of the jog dial display 214 follows the movement of the finger. In other words, that rather being displayed in the middle of the touch location of the user inside the jog dial region 212, the position of the jog dial display 214 is positioned such that the user can see it. As displayed in FIG. 3(b), the finger proceeds in a downward motions, but the jog dial display 214 is drawn slightly above the position of the finger press as to not be obstructed from view of the user. In a similar fashion, if the indicated movement of the jog dial display 214 were indicated from left to right, then the position of the jog dial display 214 would be slightly to the left, or slightly behind the indicated direction. Incidentally, in such a case, the left side relative to the position of the finger, the display area 214 may not be exposed.

Furthermore, the ring shaped region between these center button 211 and a jog dial 212, the cycle bar 213 is displayed. As described below, the “Cycle Bar” In the present invention, shows the progress of the long pressed state of the button, it is a display for confirming that the long press has been determined.

The operation panel display unit 131, the center button 211, in addition to the jog dial 212 and cycle bar 213, may be able to view the other operation button (eg, keyboard, etc.).

Furthermore, the center button 211, the external shape of the jog dial 212 and the cycle bar 213 is arbitrary, for example, the case of forming the center button 211 to the polygonal or elliptical shape, etc., the jog dial 212 and the cycle bars 213 polygonal or oval also formed in the ring are included in the invention.

Gesture detection unit 132, when the operator has performed a touch operation on the touch panel unit 112, from the touch panel unit 112, receives the coordinate signal indicating the touch position coordinates. The gesture detection unit 132, the coordinates and indicated by the coordinate signal, based on the temporal change of the coordinates, to determine the gesture of touching operation the operator has conducted.

Specifically, the gesture detection unit 132, when the operator touches the center button 211 with the thumb or touching device, when it is released within a predefined time, the touch operation is determined as a tap operation to the center button 211.

In another case, when the operator touches the center button 211 with the thumb or touching device, in the case of continued touch more than a predefined time, the gesture detection unit 132 determines that this touch operation is long depression of the center button 211.

Moreover, after the operator touches the thumb or touching device the jog dial 212, in the case of moving the touch position in the rotation direction along the jog dial 212 (clockwise or counterclockwise), the gesture detection unit 132 determines the touch-operation to be a swipe operation on the jog dial 212.

Note that the gesture detection unit 132 may be able to recognize other types of touching operation or touching other screen region, in addition to the described touching operation. For example, a tap operation on the area of displays in the list 220 of FIG. 2 may include swipe, pinch-in, pinch-out operation, and so on

Operation determining unit 133, based on the detection result of the gesture detection unit 132 determines the operation content corresponding to the touch operation.

Specifically, as described later, the operation determination unit 133, if the swipe operation of the jog dial 212 is being performed, in accordance with the movement amount and movement direction of the touch position (clockwise or counterclockwise), control to switch the items to be selection candidates (hereinafter referred to as “candidate switching control”) is performed. Then, an instruction signal for changing a screen display or other operation is sent to the control unit 120 according to the switching result of the selection. Incidentally, the candidate switch control includes, for example, moving a menu item to focus control and other operations to change the candidate value to be displayed.

Further, the operation determining unit 133, when the tap operation to the center button 211 is performed, then the control to confirm the selection of the item that is a selection candidate (hereinafter, referred to as “select and confirm control”) is achieved. In response to the select and confirm the results, an instruction signal for changing a screen display or the like, and sends to the control unit 120. In this specification, there is a case to express the operation determination unit 133 sends a command to the controller 120, as the control unit 120 executes processing for the instruction, that the operation determination unit 133 executes the process.

In addition, the operation determining unit 133, when a long press operation on the center button 211 is performed (described later) as well as changing the display of the cycle bars 213, only one level of hierarchy to be operated in the upper direction the switching control (hereinafter referred to as ‘hierarchical switching control’) is performed. Then, the operation determination unit 133, a command signal for changing a screen display or the like according to the hierarchical switching results, transmits to the control unit 120.

In addition to these instructions, the operation determining unit 133 may generate other instructions and send to the control segment 120. For example, the gesture detection unit 132 described above, when detecting a touching operation on the display area such as list 220, it may send the commands corresponding to these touch operations to the control segment 120.

FIGS. 3-6, in particular, show the description of the operation of the tablet terminal 100 according to the first embodiment (i.e. exemplary representation) of the present device.

At first the operation of selecting from the display, the desired items from a corporate name list by using tablet terminal 100 will be shown. At the first step, the operator operates the OS (Operating System) of the tablet 100 to start application software. Thus, the control segment 120 (FIG. 1) displays the title 301 (here, ‘the corporate name list’) on the display screen 200 of the display unit 111 according to the command signal from the operation panel (FIG. 3(a)).

The title 301 includes a start button 302. Then the operator performs the tapping operation on the start button 302, an operation panel 210 and the first screen of the list 220 is displayed on the display screen 200 (FIG. 2 above). Operation panel 210 includes the center button 211, a jog dial 212, a cycle 213 bar as described above.

List 220 composes a hierarchical item list. Here, the top layer of the list 220 is a list of items that indicates the first character of the corporate name. Specifically, the top level item list L11 contains initials from ‘A’ to ‘Z’. FIG. 2 shows the sample state of displaying ‘A’. Instead of the alphabet, it may be used with other phonetic characters, and may use a combination of them and alphabets. The information making up the list 220 is assumed to be stored in the storage unit (not shown). Also, the information or other data for constituting the operation panel 210, is assumed to be set in the storage unit (not shown).

Next, the operator, by touching the jog dial 212 on the display screen 200 with the thumb or touching device, performs a swipe operation (see FIG. 3(b)). Accordingly, the operation determining unit 133 (see FIG. 1), according to the moving amount and the moving direction of the swipe operation, it performs a candidate of switching control. The control unit 120 switches sequentially the selected candidates to display on the display unit 111. In the case of a swipe operation to rotate moving the touch position of thumb or other touching device in a clockwise direction of alphabetical order (i.e. from ‘A’ to ‘Z’), the item is selected in accordance with the amount of movement.

Third, the operator, performing the tap operation on the center button 211, the operation determining unit 133 performs a selection confirmation control. Thus, selection for item that is a selection candidate at that time is determined. FIG. 3(c) shows the case where item ‘C’ is determined to be selected.

This ‘selection confirmation control’, the operation target of the operation panel 210 moves to the item list corresponding to the lower of the determined item. In the first embodiment, the item list L12 from the second layer from the top includes the items of one or more of the ‘registered corporates’. In the example of FIG. 3(c), the sub items list corresponding to the item ‘C’, namely, a list of registered companies to read the names beginning with ‘C’ is displayed. At this time, the display area of the roster 220, for each item (registered company), name, and address, and phone number are displayed.

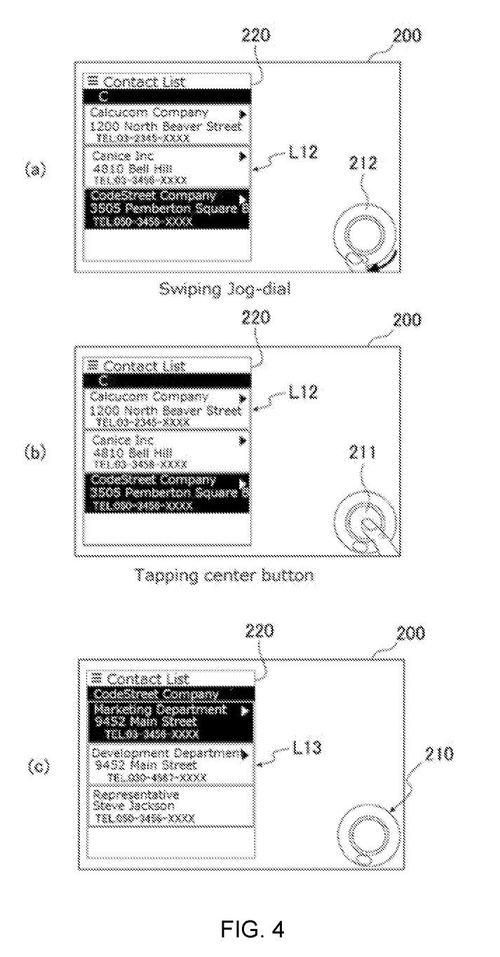

Subsequently, the operator, performing the swipe operation of the jog dial 212, the operation determination unit 133, selection candidate (i.e. registered corporate) is sequentially switched according to the amount of movement and the direction of the swipe operation (FIG. 4(a)). In the first embodiment, by highlighting the item in the selected candidate, thereby facilitating identification of an item is not a selection candidate. As a method of highlighting, a method of changing a display color between items and other items of the selected candidates, a method of changing the background color, there are other possible methods such as changing the font or thickness of the character, and so on.

In addition, the operator, performing the tap operation on the center button 211, the operation determination unit 133 controls the selection and establishment of choices, to confirm the selection for the item has become a selection candidate (i.e. registered corporates) at that time (FIG. 4(b)). By this selection and establishment of choices control, the operation target of the operation panel 210, the process moves to a list of items corresponding to the lower of defined items (i.e. registered corporates). In the first embodiment, the item list L13 from the third layer from the top includes one or more ‘department’ of the registered corporates as items (FIG. 4(c)). At this time, the display area of the corporates name list 220, for each item (i.e. ‘department’), the name, the address and phone number are displayed.

Subsequently, the operator, performing the swipe operation of the jog dial 212, the operation determination unit 133, according to the amount of movement and the direction of the swipe operation, sequentially switches the selection candidates item (i.e. ‘department’)

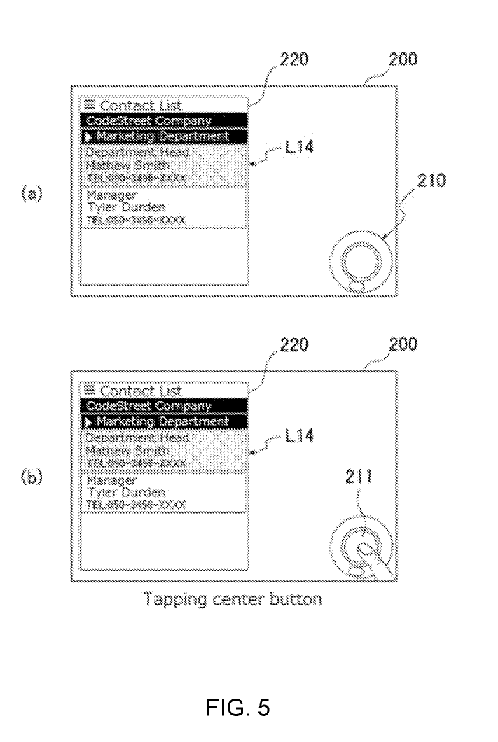

Then, the operator, performing the tap operation on the center button 211, the operation determining unit 133 performs a selection confirmation control to confirm the selection to the item in the selected candidate (i.e. ‘department’) at that time. By this selection and establishment of choices control, the operation target of the operation panel 210 moves to the list of items corresponding to the lower layer of determined items (i.e. ‘department’). In the first embodiment, the item list L14 from the fourth layer from the top includes one or more ‘employee’ belonging to the department (FIG. 5(a)). At this time, the display area of the corporates name list 220, title, name and phone number are displayed for each item (i.e. ‘employee’).

Then, the operator, performing the swipe operation of the jog dial 212, the operation determination unit 133, according to the moving amount and the moving direction of the swipe operation, sequentially switched to selected candidate (i.e. ‘employee’).

Furthermore, the operator, performing the tap operation on the center button 211, the operation determining unit 133 performs a selection confirmation control to confirm the selection to the item in the selected candidate (i.e. ‘employee’) at the time (FIG. 5(b)). As a result, on the display area of the corporates name list 220, information such as the history of the selected employee are displayed.

Next, an operation for returning from the item list that is displayed in the upper of the item list in the first embodiment of present invention will be described.

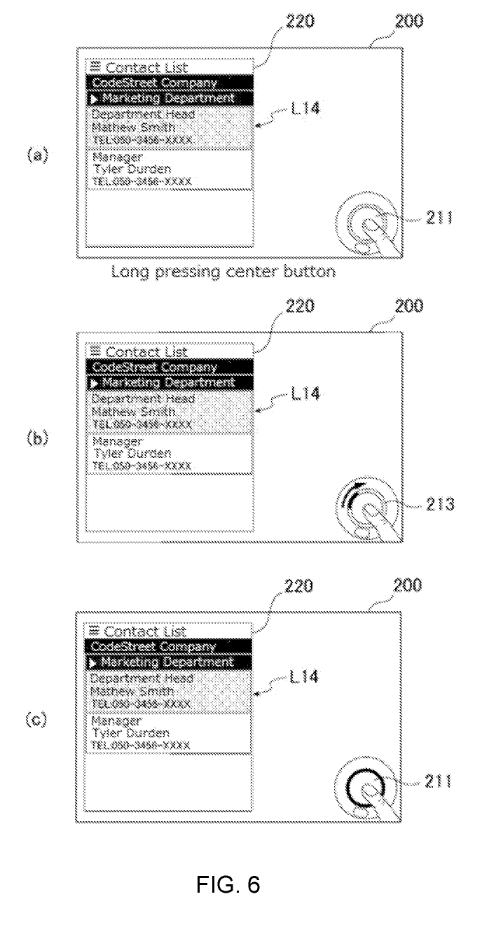

In the first embodiment, in order to return to the upper item list, the long press operation on the center button 211 is implemented (FIG. 6(a)). Thus, the operation panel 210, short cycle bar 213 is displayed (FIG. 6(b)). Then, the cycle bar 213, the operator can continue the long press operation of the center button 211 (i.e. continuing the touch on the center button 211), in accordance with the touch time, extends in a circular arc direction. When the touch time reaches a predefined time, its front end and a rear end are connected and becomes to be a ring shape (FIG. 6(c)). Operation determining unit 133, the cycle bar 213 by performing a hierarchical switching control at the time of forming the ring, it switches the item list to be displayed on the display screen 200 up one tier (FIG. 4(c)). Here, it is assumed that the item list is returned to one upper layer in a single switching control, it is also possible to be returned to two or more upper layers in a single switching control.

Here, the operator further continues to press and hold operation on the center button 211, in the same area as this is first cycles bar 213, second cycle bar 213 is displayed. The second cycle bar 213, it is necessary to visually distinguished from the first, for example, or displayed in a color different from the first one cycle bar 213, the display of the first one cycle bar 213 It is desirable to or displayed after erasing. The second cycle bar 213 also, when it appears to have the short form of the arc, the operator can continue the long depression of the center button 211, extends in a circular arc direction in accordance with the touch time. When the touch time reaches a predetermined time, with the second cycle the bar 213 is in a ring shape, an item list to be displayed on the display screen 200 is switched to the higher by one level.

By repeating the display of such a cycle bar 213, the operator can recognize the number of layers in which the item list has moved visually.

According to this process, each time the long press time of the center button 211 becomes an integral multiple of the predetermined time period, as well as item list can be back up one tier, the cycle bar 213, a predetermined time the number of times has been reached it can be confirmed easily. Thus, according to the first embodiment, by continuing to press and hold operation, a list of items displayed on the display screen 200, easily, and can be returned to the arbitrary layer.

Then, the operator, and to end the long press operation on the center button 211, the cycle bar 213 disappears from the display.

As described above, according to the first embodiment, it is possible to select each item by swipe along the jog dial 212 of the ring, to be moved to a lower item list at the tap operation to the center button 211 can be so short time with easy operation, it is possible to select a desired item from the hierarchical list of items.

Further, according to the first embodiment, it is possible to return to the upper hierarchy easily by long press operation on the center button 211.

Also as described above, the operation determining unit 133 performs control to change the display cycle bar 213 in response to a touch time which the gesture detector 132 obtained. Moreover, the display changes in the cycle bar 213, the user can change the User Interface (e.g., to move to the menu hierarchy) can be visually recognized.

Note that for example, the operation determining unit 133 continuously detects a touch time is the time to obtain calculated that a touch to the gesture detection unit 132 is the center button 211, N hierarchies corresponding to the length of the touch time (N may be performed hierarchical switching control back to one or more natural number) on. Incidentally, the more the longer the touch time, it is of course a tendency that N is large. For example, by increasing function of the touch time as a parameter, N is determined. However, the final hierarchy may reach a hierarchical switching control, and it is needless to say that the highest layer.

Furthermore, in the first embodiment, hierarchical menu item (item list), the amount of movement of the hierarchy (one level or two levels on either or else), and visually by the color of the cycle bars 213 It explained how to distinguish. However, the operation determining unit 133, by any of the attribute values of the cycle bar 213 may be displayed to be visually distinguished from the amount of movement of the hierarchy. Thus, for example, the operation determining unit 133, the thickness of the cycle bars 213, shape (for example, the solid line and the broken line and one-dot chain line, etc.) or other methods can be used so as to visually distinguish the movement of the hierarchy.

In the present embodiment, the display screen 200 of the display unit 111, it is preferable position of the operation panel 210 is customizable. For example, the user's instruction, the operation panel display unit 131, an operation panel 210, or located at the lower right on the display screen 200, or placed in the lower left, it is preferred to or placed in the center below the is there. In other words, the storage unit (not shown), location information for specifying the position of the operation panel 210 (for example, coordinate values, flags, etc.) are set, the operation panel display unit 131, according to such arrangement information, an operation panel 210 Deploy. Further, arrangement information, as described above, the user's instruction, it is preferable is changeable. Furthermore, depending on the screen being displayed, so as not to disturb the operation of the screen, the area number or area is small object is located, to automatically change the arrangement position of the operation panel 210 is preferable.

Furthermore, by detecting the inclination of the information display device, in response to the degree of inclination, it is preferable to automatically change the arrangement position of the operation panel 210. For example, the operation managing unit 130, a gyro sensor or other sensing device implemented on the information display device, to obtain information about the tilt of the information display device. Then, the operation managing unit 130, from the information on the slope, if the information display apparatus is determined to be inclined to the right are arranged on the right side (eg, lower right) of the display screen of the operation panel 210, if it is determined to be inclined to the left side, it is arranged on the left side (eg, lower left) of the display screen of the operation panel 210.

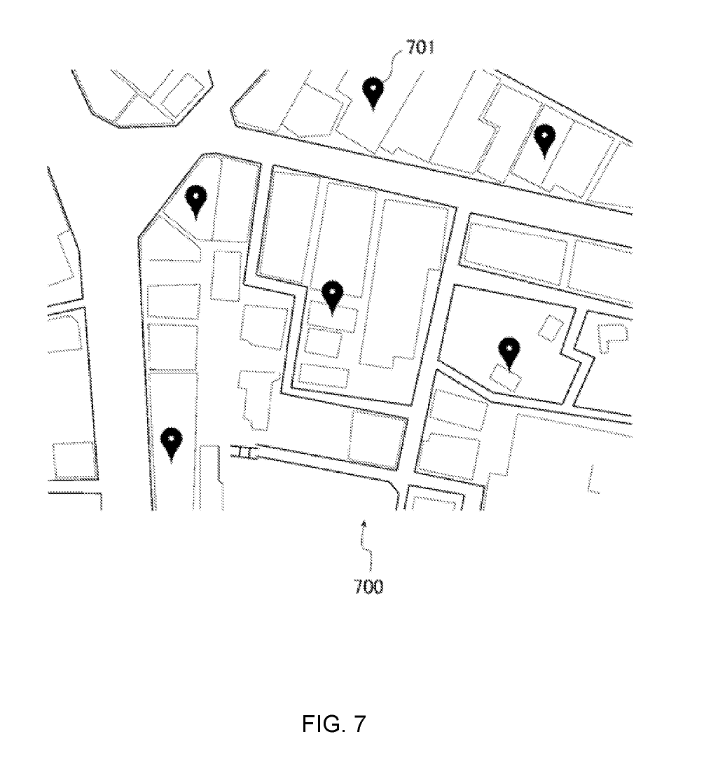

Referring now also to FIGS. 7-9 in the drawings, a second exemplary representation of information display device 100 is illustrated. Description of the second exemplary embodiment is described herein.

The functional configuration of the tablet according to the second embodiment is the same as the first embodiment (FIG. 1), description thereof will be omitted. Incidentally, similarly to the first embodiment, it is obvious that tablet terminal can be replaced by smartphone, personal computer, and so on.

In tablets according to the second embodiment, when starting the application software, a map is displayed on the display screen 700 as shown in FIG. 7. The map in correspondence to the location of customers registered, the position marks (pin) 701 is displayed. Incidentally, we assume that the map information indicating the location of customers, information about customers, symbol, etc. of the position mark is stored in the storage unit (not shown).

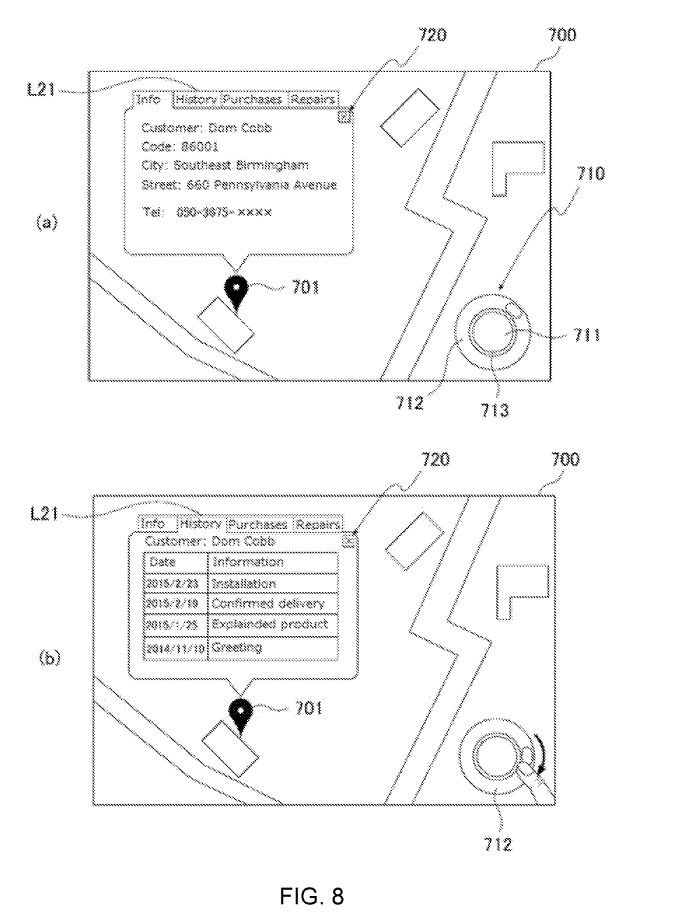

The operator, for example, by performing a tap operation, selecting one of the position mark 701, the display screen 700, as well to zoom the map display in accordance with the position mark 701 is selected, the operation panel 710 displays differentially. Furthermore, in the vicinity of that position mark 701 (e.g. top), the customer company customer information 720 is displayed the balloon (FIG. 8(a)). Here, the map display center coordinates after the zoom, when you display the position mark 701 and the customer information 720 at the same time, so that they become easy to see, in the case of a position shifted from the position mark 701 (FIG. 8(a) the upper left of the predetermined coordinate point) of the position marks 701, it is desirable to set the center coordinates of the map display.

As in the first embodiment described above, the operation panel 710 contains the center button 711, a jog dial 712 and a cycle bar 713.

Customer information 720 is composed of layered item list. The most significant item list L21 of the customer information 720 is a list of item indicating the type of information. That is, the most significant item list L21 of, as an item, contains a ‘customer name’, ‘visit history’, ‘purchase record’ and ‘repair record’. As shown in FIG. 8(a), when the operator has performed a tap operation on the position mark 701, customer information 720, the balloon is displayed with selected ‘customer name’.

Next, the operator performs the swipe operation by touching the jog dial 712 with thumb for example. Accordingly, the operation determining unit 133 (FIG. 1) performs the candidate switching control in accordance with the movement amount and movement direction of the swipe operation, sequentially switching and displaying the entries of the selected candidate. In the second embodiment, the case of a swipe operation to rotate moving the touch position, such as the thumb in a clockwise direction, in accordance with the amount of move, the target item is switched in the order to ‘Customer name’→‘visit history’→‘purchase record’→‘repair record’→‘Customer name’→ and so on. Conversely, if the swipe operation to rotate moving the touch position in the counterclockwise direction, in accordance with the amount of move, the target item is switched in the order to ‘Customer name’→‘visit history’→‘purchase record’→‘repair record’→‘Customer name’→ and so on. FIG. 8(b) shows a case where ‘visit history’ is designated as an item of selection candidates.

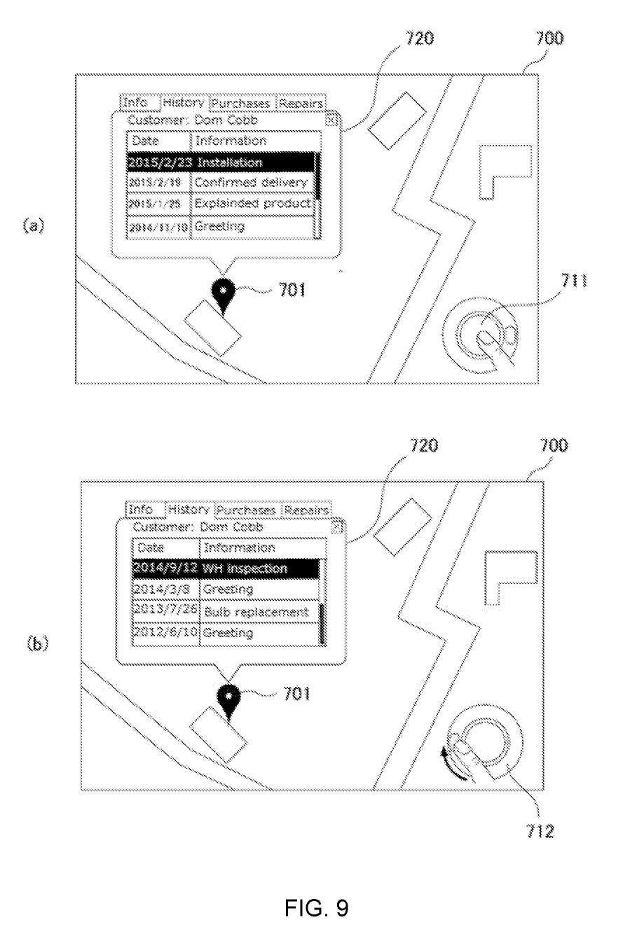

Then, the operator, performing the tap operation on the center button 711, the operation determining unit 133 (FIG. 1), confirms the selection to the item that is the selection candidate at that time (in this sample, ‘visit history’) the selection confirmation control to perform (FIG. 9(a)).

Further, the operator, for example, when performing swiping operation on the jog dial 712 with the thumb, the operation determination unit 133, according to the moving amount and the moving direction of the swipe operation items (visiting history of the selection candidate ‘purpose’) sequentially switches the reference (FIG. 9(b)). In the second embodiment, by highlighting the item in the selected candidate, thereby facilitating identification of an item is not a selection candidate.

Note that in the second embodiment, if you want to return to the upper item list, as in the first embodiment described above, perform the long pressing operation of the center button 711, it is sufficient to perform a hierarchical switching control. In this case, similarly to the first embodiment described above, by displaying the cycle bar, the operator, the number of hierarchy item list is returned and can be visually recognized.

As described above, by the second embodiment, similarly to the first embodiment described above, it is possible to select each item by swipe along the jog dial 712 of the ring, the tap operation to the center button 711, and to confirm the selection, it is possible to move to a lower item, a short time in a simple operation, it is possible to select a desired item from the hierarchical item list.

Further, by the second embodiment, a long depression of the center button 711, it is possible to move up the hierarchy, a list of items displayed on the display screen, return to hierarchy by easy operation.

In addition, according to the second embodiment, by using the position mark 701 on the map, so selecting the corresponding company information, it is possible to select an item list short time by an easy operation. Here, while it has been decided to select corporate information in tap operation, specifying the position mark 701 to be a selection candidate by swiping operation on the jog dial 712 to the position mark 701, a tap operation on the center button 711 the first screen (FIG. 8(a)) of corporate information may even be displayed. In this case, the most significant item of the “layered item list” in the present invention, is their position mark 701.

In the present embodiment, the operation panel 710, rather than immediately after starting the application, after starting the application, when the user instructs the position mark 701, is displayed. In other words, the operation managing unit 130 detects the operation, the operation is predefined specific operation (for example, the position mark 701 instructing operation) when the event for displaying the operation panel 210 is generated. The control unit 120, based on this event, performs control for displaying an operation panel 210 on the display section 111. Such process, if the control panel 210 need only be able to display the operation panel 210 can be used effectively.

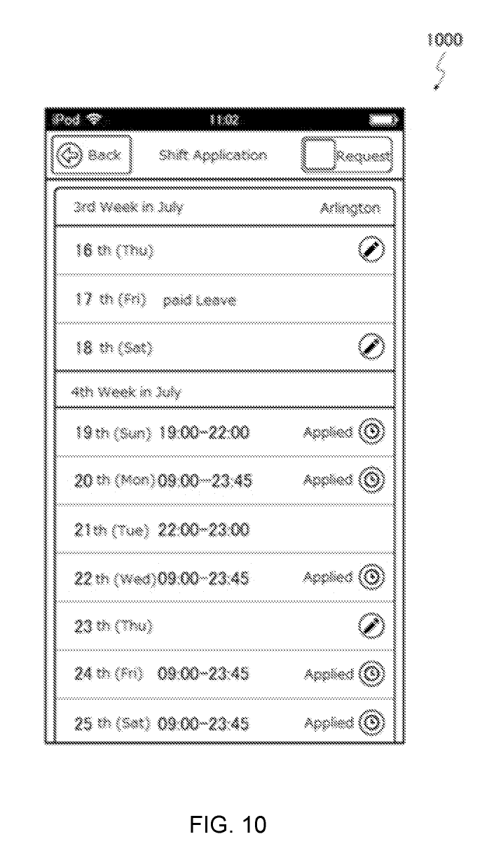

Referring now also to FIGS. 10-15 in the drawings, a third exemplary representation of information display device 100 is illustrated. Description of the third exemplary embodiment is described herein.

The functional configuration of the tablet according to the third embodiment is the same as the first embodiment (FIG. 1), description thereof will be omitted. Incidentally, similarly to the first embodiment, it is obvious that tablet terminal can be replaced by smartphone, personal computer, and so on.

The tablet according to the third embodiment, a calendar 1000, as shown in FIG. 10 is displayed on the display screen. This calendar 1000, part-time employees, the workplace is a calendar to apply for wishing attendance time of employees.

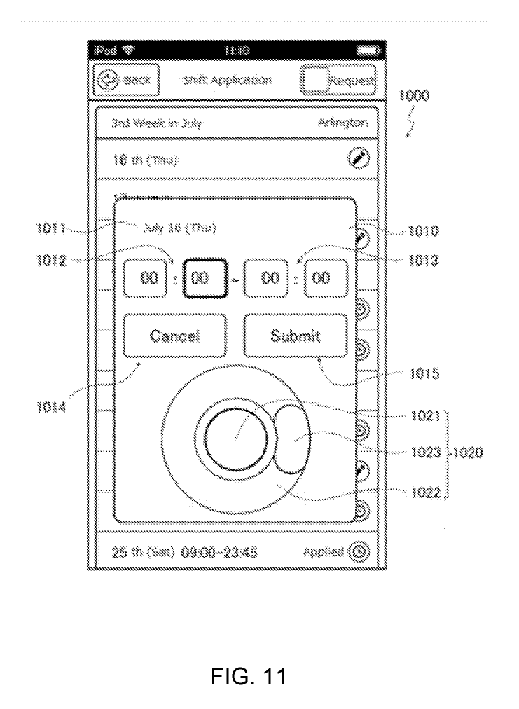

Then, the operator, for example, select one of the date column by performing a tap operation, on calendar 1000, working hours input screen 1010 for inputting a desired working hours of the selected date is displayed (FIG. 11).

The working hours input screen 1010, the date 1011, and attendance time entry field 1012 to enter the work start time, and the clock-out time entry field 1013 to enter the work end time, and a cancel button 1014, a transmission button 1015, an operation and the panel 1020 are displayed. Here, attendance time entry field 1012 and the clock-out time entry field 1013 corresponds to the ‘first entry field’ of the present invention.

Further, the operation panel 1020 includes a center button 1021, and a jog dial 1022. Further, this jog dial 1022, the display area 1023 of the elliptical shape indicating the position of the finger is provided. If you touch the jog dial 1022, the display area 1023 of the elliptical shape is moved to the position of the finger touch, it becomes ready for swipe.

When working hours input screen 1010 is displayed, one of attendance time entry field 1012 and the clock-out time entry field 1013 if attendance time entry field 1012 is selected. And in this attendance time entry field 1012, as a selection candidate for the item (in this case, time data) to be input, 0:00 is displayed.

In this state, the operator, as described below, by operating the display area 1023 of the elliptical shape of the jog dial with a finger or the like, the operation determining unit 133 (FIG. 1), attendance time entry field 1012 and clock-out times. It wants to set the time for the entry field 1013. Here, after setting the hour and minute of attendance time entry field 1012 at the same time, will be described an example of setting the hour and minute of the clock-out time entry field 1013 at the same time, the a ‘minute’ and ‘time’ attendance time after individually set, it may be set individually and ‘time’ and ‘min’ the clock-out times.

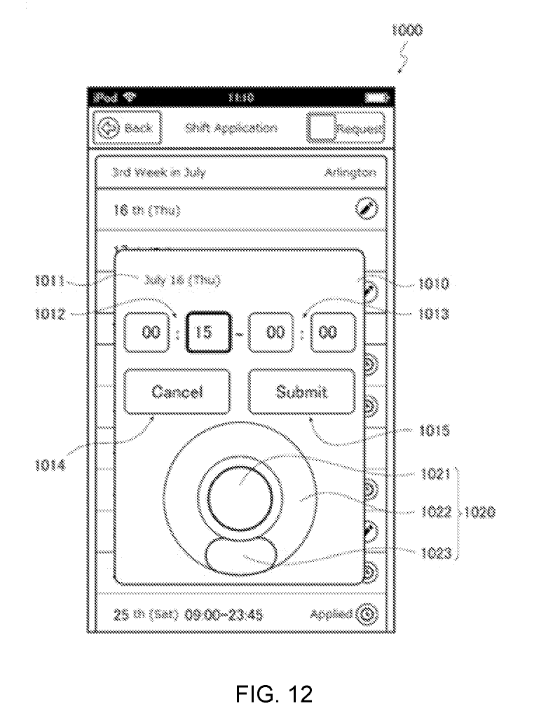

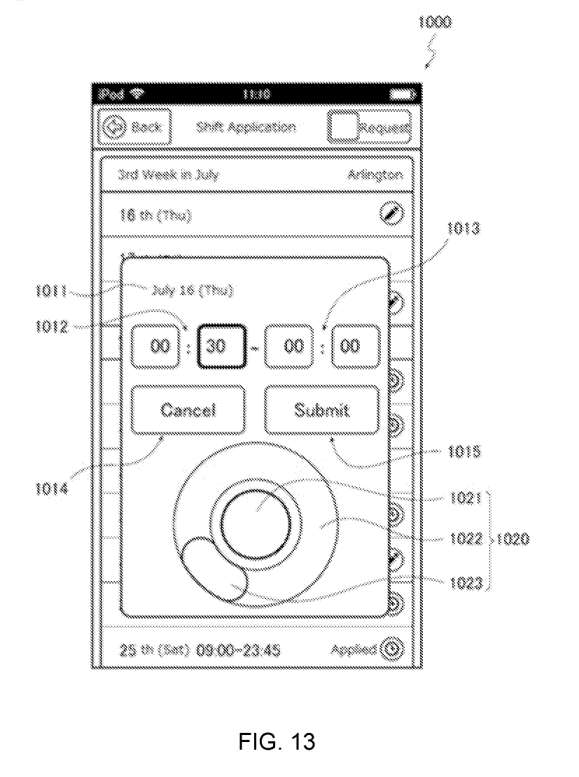

First, the operator, by touching the display area 1023 of the jog dial 1022 or an elliptical shape, when a swipe operation of moving the touch position by a predetermined amount in the clockwise direction, moving the display area 1023 of the elliptical shaped accordingly is, display time of attendance time entry field 1012, the process proceeds to 0:15 minutes to 0:00 (FIG. 12). Thereafter, the cell is moved further predetermined amount in the clockwise direction to the touch position, the display area 1023 of the elliptical shape is moved, the display time of the attendance time entry field 1012 proceeds to 0:30 minutes to 0:15 accordingly (FIG. 13). Meanwhile, the touch position, and is moved in the counter clockwise direction, the display time of the attendance time entry field 1012, each 15 minutes and retracted (not shown in figure).

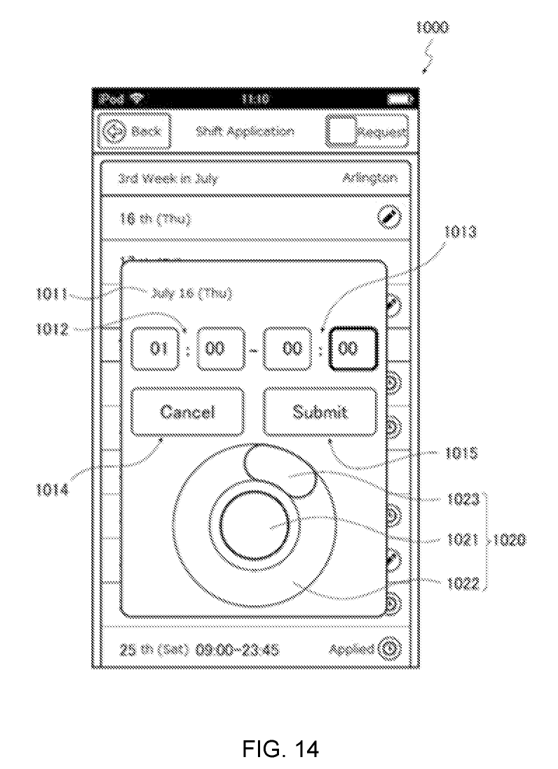

Then, when the desired time to attendance time entry field 1012 (here and 1:00) is displayed, the operator, tap the center button 1021. As a result, the time data is inputted to the attendance time entry field 1012 is determined, the entry field to be selected, is switched from the attendance time entry field 1012 to the clock-out time entry field 1013 (FIG. 14).

In this state, the operator, performing the swipe operation by touching the jog dial 1022 or the display area 1023 of the elliptical shape in the thumb or the like, the operation determining unit 133 (FIG. 1), the moving amount and the moving direction of the swipe operation display area 1023 of the elliptical shape is moved, a change in the display time of the clock-out time entry field 1013 in response to. Here, the display time of the clock-out time entry field 1013 is also in accordance with the movement amount and the moving direction of the swipe (clockwise or counterclockwise), it is assumed that the traveling or backward by 15 minutes each.

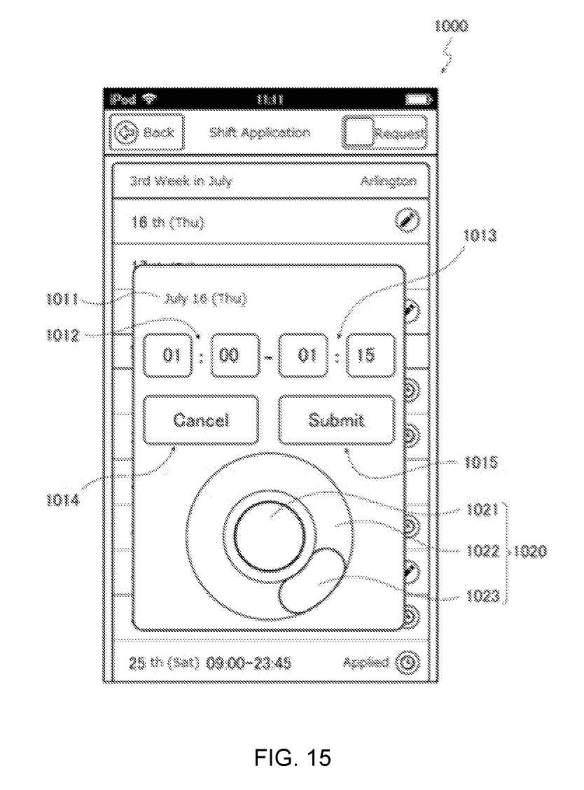

Then, when the desired time to the clock-out time entry field 1013 (here, 1:15) is displayed, the operator, tap the center button 1021. Thus, time data is input to the clock-out time entry field 1013 is determined (FIG. 15).

Then, the operator tapping such a send button 2015, the time data input to the attendance time entry field 1012 and the clock-out time entry field 1013 is transmitted. On the other hand, the operator and to tap such as the cancel button 1014, been removed time data that is input to the attendance time entry field 1012 and the clock-out time entry field 1013, the original time (attendance time entry field 1012 and the clock-out time entry field 1013 but both 0:00 of the state, and returns (FIG. 11)).

In this manner, according to the third embodiment, by the tap operation to swipe operation and center buttons 1021 to the jog dial 1022, the input and the determination of time data to the attendance time entry field 1012 and the clock-out time entry field 1013 The so performed, as compared with the case of the operation of selecting from a list that was the case or down using conventional screen keyboard, screen operation when entering a desired working time in working hours input screen 1010 is simplified.

That is, in the third embodiment, the gesture detection unit 132 detects a swipe operation on the jog dial 1022. Then, in response to swipe operation, the operation determination unit 133 is multiple candidate values which are predetermined can be entered in the entry field is focused, among the multiple candidate values with a sequence in the entry field display the candidate value which is changed in the order continuously.

Here, it has been described by taking as an example the case of inputting the time data in the entry fields, even in the case of inputting the other types of items in the entry field, and can be applied to the operation panel 1020 of the third embodiment obviously.

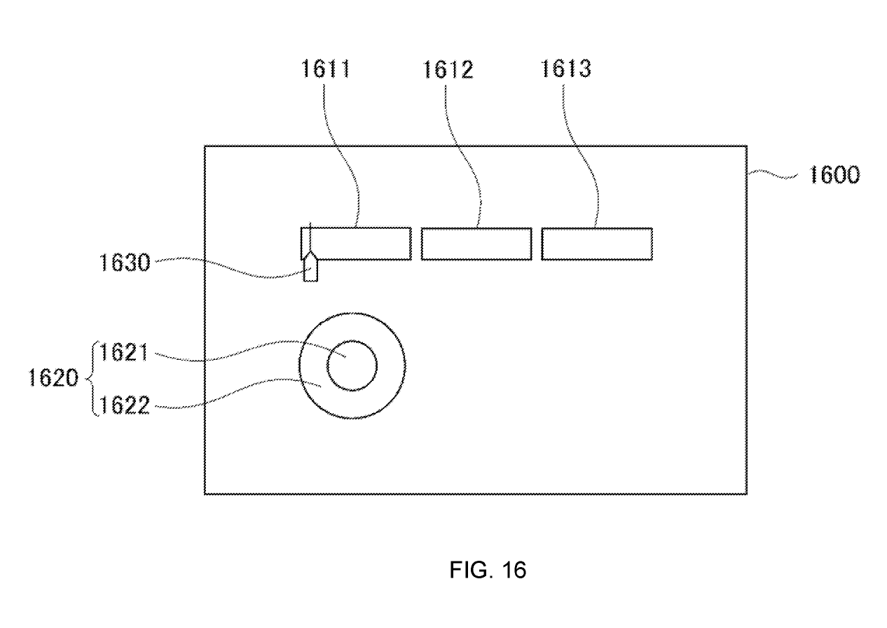

Referring now also to FIGS. 16-21 in the drawings, a fourth exemplary representation of information display device 100 is illustrated. Description of the fourth exemplary embodiment is described herein.

The functional configuration of the tablet according to the fourth embodiment is the same as the first embodiment (FIG. 1), description thereof will be omitted. Incidentally, similarly to the first embodiment, it is obvious that tablet terminal can be replaced by smartphone, personal computer, and so on.

The doublet terminal according to the fourth embodiment, for example, an input screen 1600 as shown in FIG. 16 is displayed. This input screen 1600, entry fields 1611, 1612, 1613 as a ‘second entry fields’ of the present invention, and the operation panel 1620 are displayed.

The operation panel 1620 is provided with a center button 1621, and a jog dial 1622.

In the fourth embodiment, when the input screen 1600 is displayed, among of the entry fields 1611 to 1613, entry field 1611 is selected. Thus, we assume the cursor 1630 appears in the entry field 1611.

In this state, when the operator performs the sliding operation as described below, the operation determining unit 133 (FIG. 1) performs a field switch control to change the selection of the entry fields 1611 to 1613.

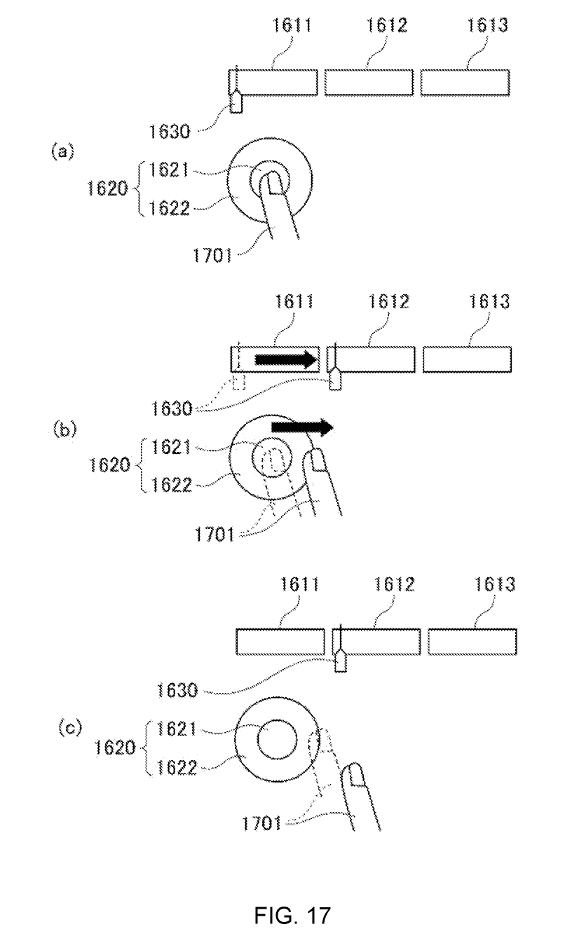

FIG. 17 is a conceptual diagram showing an example of a slide operation according to the fourth embodiment.

First, the operator touches the center button 1621 (FIG. 17(a)) by finger 1701 or other touching device.

Then the operator moves the touch position to the right direction. Thus, the touch position can be overlapped on the boundary between the center button 1621 and a jog dial 1622, it moves to the outside (FIG. 17(b)). As a result, the cursor 1630 is moved from the entry field 1611 to the entry field 1612.

Then the operator releases the finger 1701 or other touching device from the screen, it becomes ready to input to the entry field 1612 (FIG. 17(c)).

Thus, the operator after touching the center button 1621 and moves the touch position to the right, the cursor 1630 can be moved to the right entry field.

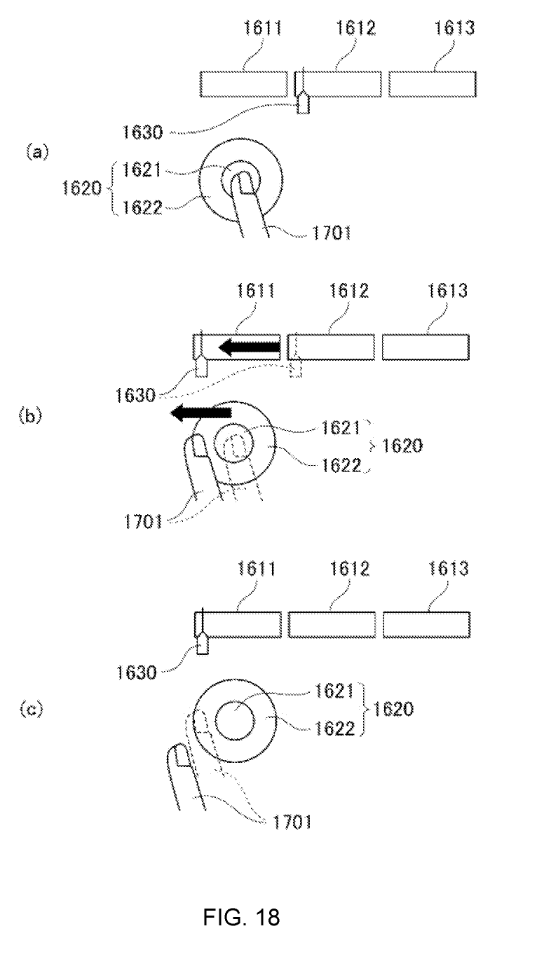

FIG. 18 is a conceptual diagram showing another example of a slide operation according to the fourth embodiment.

At first the operator touches the center button 1621 with a finger 1701, etc. (FIG. 18(a)).

Then the operator moves the touch position to the left direction. Thus, the touch position can be overlapped on the boundary between the center button 1621 and a jog dial 1622, it moves to the outside (see FIG. 18(b)). As a result, the cursor 1630 is moved from the entry field 1612 to the entry field 1611.

Then, the operator, release the finger 1701 or other touching device from the screen, it becomes ready to input to the entry field 1611 (FIG. 18(c)).

Thus, the operator after touching the center button 1621 and moves the touch position to the left, the cursor 1630 is moved to the left entry field.

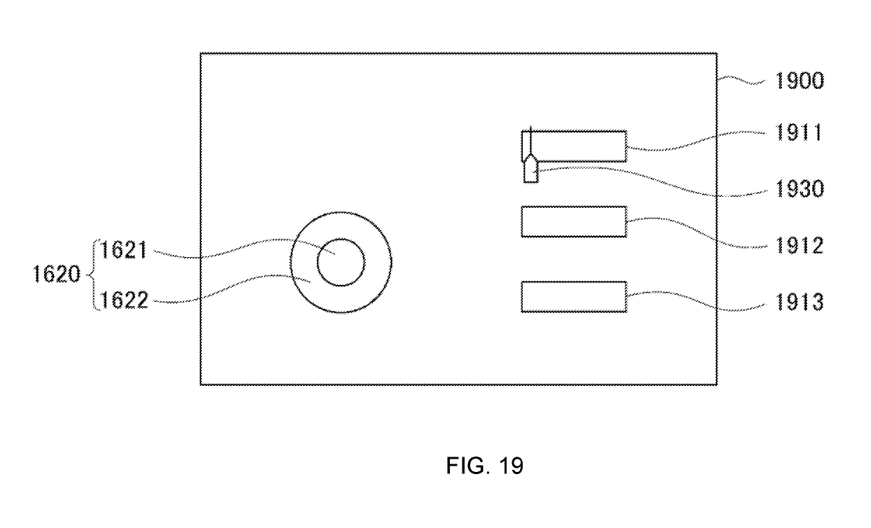

FIG. 19 shows another example of the input screen. The input screen 1900 of FIG. 19, with entry field 1911, 1912, 1913 as ‘second entry fields’ of the present invention are displayed side by side in the vertical direction, the operation panel 1620 are displayed. The operation panel 1620 is equipped with a center button 1621, and a jog dial 1622 as shown in FIG. 16.

In the example of FIG. 19, when the input screen 1900 is displayed, one of the entry field 1911 is selected among of the entry fields 1911 to 1913. Accordingly, the cursor 1930 is assumed to appear in the entry field 1911.

In this state, the operator, performing the sliding operation as described below, the operation determining unit 133 (FIG. 1), performing a field switch control, to change the selection of input columns 1911 to 1913.

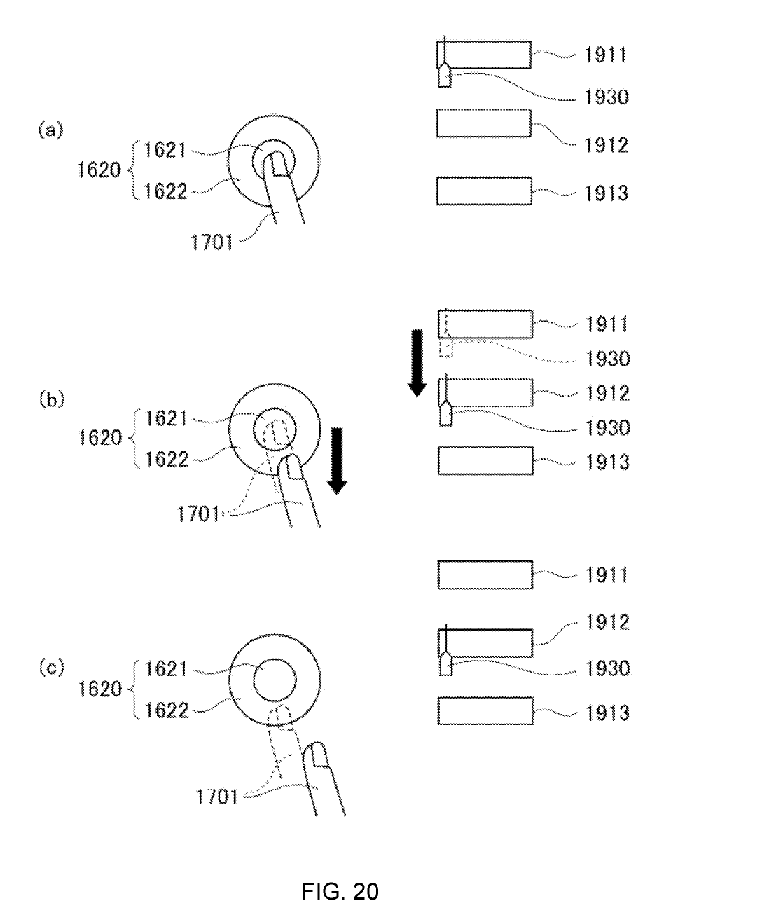

FIG. 20 is a conceptual diagram showing an example of a sliding operation on the input screen 1900 of FIG. 19.

At first the operator touches the center button 1621 (FIG. 20(a)) with finger 1701 or other touching device.

Then the operator moves the touch position to the downward direction. Thus, the touch position can be overlapped on the boundary between the center button 1621 and a jog dial 1622, moved to outside (FIG. 20(b)). As a result, the cursor 1930 is moved from the entry field 1911 to the entry field 1912.

Then the operator releases the finger or other touching device from the screen, it becomes ready to input to the entry field 1912 (FIG. 20(c)).

Thus, the operator, after touching the center button 1621, moves the touch position to the downward direction, the cursor 1930 can be moved to the lower entry field.

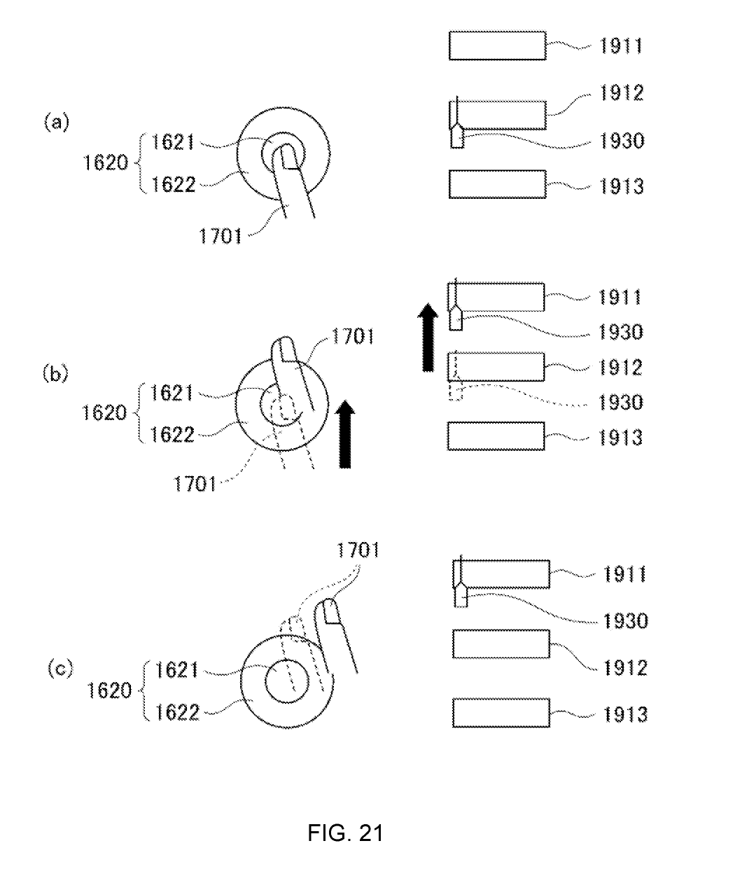

FIG. 21 is a conceptual diagram showing another example of a sliding operation on the input screen 1900 of FIG. 19.

At first, the operator touches the center button 1621 with a finger 1701, etc. (FIG. 21(a)).

Then the operator moves the touch position upward. Thus, the touch position can be overlapped on the boundary between the center button 1621 and a jog dial 1622, moved to the outside (FIG. 21(b)). As a result, the cursor 1930 is moved from the entry field 1912 to the entry field 1911.

Then the operator releases the finger 1701 or other touching device, it becomes ready to input to the entry field 1911 (FIG. 21(c)).

Thus the operator, after touching the center button 1621, moves the touch position to the upward direction, the cursor 1630 is moved in the upper entry field.

Thus, according to the fourth embodiment of present invention, according to the movement direction of the touch position in the sliding operation, it is possible to switch the entry field to place the cursor, by arranging a plurality of entry fields in the longitudinal direction and transverse direction for example, the operation of switching the entry fields becomes very easy.

Thus the gesture detection unit 132 detects the direction of touch position in the region of the jog dial 1622 after touching the center button 1621, the operation determining unit 133, performs control to the entry field which is focused, moving the focus to the entry field located in the direction.

Fourth embodiment on present invention is possible to be realized by the combination of first to third embodiments of present invention described above.

In other words, the method of focus movement using the operation panel 1620, two or more types may be present. In the first to second embodiments, the gesture detection unit 132 detects the slide operation on the jog dial 1622, the operation determining unit 133 performs control to move the focus in the direction of the object corresponding to the slide operation. Note that object and is for configuring the user interface, for example, menu items, the entry field, a button or other items. In the fourth embodiment, the gesture detection unit 132 detects the slide operation across the subsequent jog dial 1622 touch on the center button 1621, and the touch, the operation determination unit 133, in a direction corresponding to the slide operation I control is performed to move the focus to the object.

Further, in the first to fourth embodiments, with respect to the operation of the vertical and horizontal directions, the operation determination unit 133 can perform the focus movement control as described below.

For operation in the right direction and described with reference to FIG. 17, the second to swipe the center button to the right 1621 and the first swipe up jog dial 1622, the center button 1621 to outside across the jog dial 1622 the jog dial 1622 divided bets, when the first swipe from center button 1621 until jog dial 1622, and to move to the right from the entry field 1611 in the entry field 1612, although not shown, the entry field from an entry field 1613 for the right If someone were to a plurality of, performs the slide operation in the right direction from the center button 1621 to the outer jog dial 1622 across the jog dial 1622 (for the second swipe) For remains touching the finger, the entry field from the entry field 1611 1612 next beyond the entry field 1613 of it may be as it moves to the right of the field at regular intervals. At this time, the movement when you release your finger to stop. In addition, the slide operation in the right direction from the center button 1621 to the outer jog dial 1622 across the jog dial 1622 can be, while touching the finger, when pressing the center button 1621 in the second finger, and moved to the rightmost entry field, and so on.

For similar in operation to the left direction and described with reference to FIG. 18, a first swipe to the left from the center button 1621 until jog dial 1622, and the second from the center button 1621 to the outside of the cross jog dial 1622 the jog dial 1622 of the divided and swipe the case of the first swipe from center button 1621 until jog dial 1622, and to move to the left in the entry field 1612 from the entry fields 1613, although not shown, the entry field left from 1611 If someone were to a plurality of, performs the slide operation in the left direction from the center button 1621 to the outer jog dial 1622 across the jog dial 1622 (for the second swipe) the entry field from 1612 can be moved to the left entry field at regular intervals, skipping 1611. At this time, when the operator removes the finger, the movement stops. In addition, it performs a slide operation in the left direction from the center button 1621 until jog dial 1622 out across the jog dial 1622, while touching the finger, when pressing the center button 1621 in the second finger is moved into the leftmost entry field.

About Similarly operation in the downward direction, and described with reference to FIG. 20, the second of the swipe of a downward direction from the center button 1621 and the first swipe up to the jog dial 1622, from the center button 1621 until 1622 outside across the jog dial 1622 It is divided bets, when the first swipe from center button 1621 until jog dial 1622 is moved down one of the entry fields 1911 to 1912, although not illustrated, if there several input fields below the 1913 If you performs the slide operation in the downward direction from the center button 1621 to the outer jog dial 1622 across the jog dial 1622 (for the second swipe) For remains touching the finger to the next entry field 1912 from the input field 1911 Beyond the entry field 1913 may be as it moves into the field of the bottom at regular intervals. At this time, the movement when you release your finger to stop. In addition, while touching the finger performs a slide operation in the downward direction from the center button 1621 to the outer jog dial 1622 across the jog dial 1622, when you press the center button 1621 in the second finger, etc. to move to the lowermost entry field.

The operation similarly to the above direction and described with reference to FIG. 21, a first swipe upwards from the center button 1621 until jog dial 1622, the second and swipe up out of the jog dial 1622 across the jog dial 1622 from 1621 divided bets, when the center button 1621 of the first swipe up jog dial 1622 to go on one of the entry field 1912 in the entry field 1911, although not shown, the entry field above the entry field 1911 If someone were to a plurality of, performs the slide operation in the upper direction from the center button 1621 to the outer jog dial 1622 across the jog dial 1622 (for the second swipe) For remains touching the finger, the entry field from an entry field 1912 Subsequent to the 1911 beyond the entry field 1911 may be as to continue to move in the field above at regular intervals. At this time, the movement stops when the operator removes the finger. In addition, it performs a slide operation to the upper direction from the center button 1621 to the outer jog dial 1622 across the jog dial 1622, while touching the finger, when pressing the center button 1621 in the second finger is moved into the uppermost entry field.

Incidentally, a constant interval the entry field moves when the remains touching the finger operation in the vertical and horizontal directions of the above may be about 5 seconds for example, 0.5 seconds.

Although not described in the figure, the case of operation with the thumb in the case of a smart phone that can hold with one hand while holding a smart phone enables operation with the thumb, the operation of the application is remarkably improved.

In the described first to fourth embodiments above, but employs the case of applying the invention to a finger operation of the tablet in the case, the invention is of course that the example is applicable also to other operating method of the touch pen, etc.

Also, in the first through 4 above, it has been described a case of using the tablet 100 as the information display apparatus, the invention can also be applied to smart phone, and further, a printer with a touch panel, a camera, information appliances, such as a TV remote control, it can also be applied to other information display device.

Furthermore, in the first through 4 above, the display position of the operation panel 210, it has been the right or left side of the display screen 200 of the tablets 100, in the present invention, where the display position of the operation panel 210 is not restricted. For example, such as the case of smart phones that can have in one hand, the operation panel 210, may be used as the lower center of the display screen 200.

In addition, in the first to fourth of the above embodiment has been described taking the case where the cycle bar 213 becomes a ring extends on an arc in the examples, is not limited to this, every time the hierarchical switching control is executed once if the display is intended to be one revolution, it is possible to use other display method.

In addition, the first and second embodiments the hierarchical name list has been described as an example of item list, it is obvious that another type of item list is also applied.

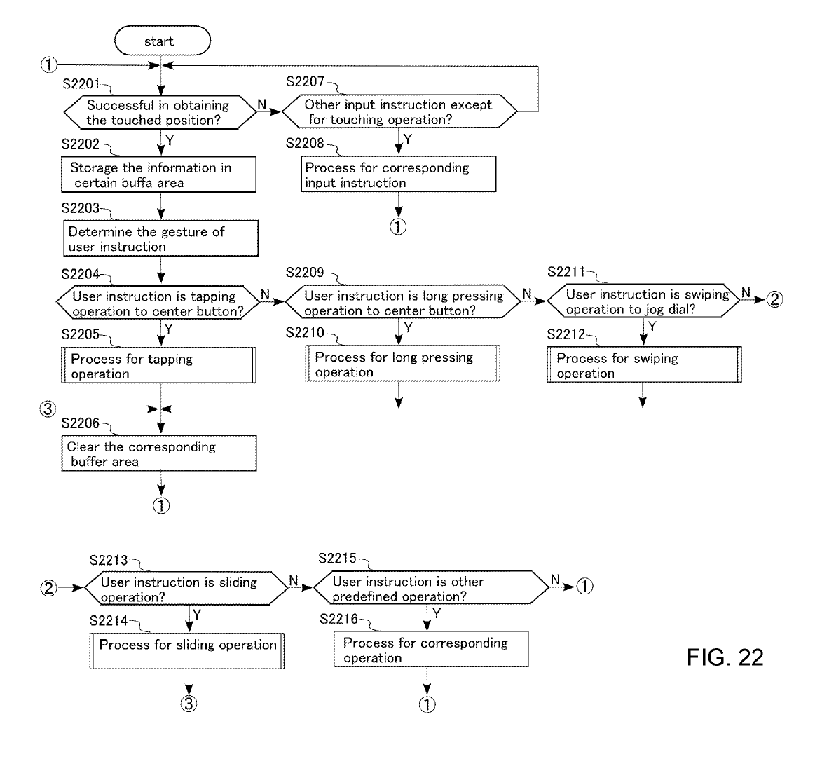

Referring now also to FIGS. 22-26 in the drawings, charts showing the behavior and operations process of the previous described embodiments/exemplary representations are more clearly described within a fifth embodiment. Description of the behavior and operations is described herein.

In the fifth embodiment of the invention, the information display device described in Embodiment Modes 1 to 4 above, are collectively described.

This information display device has a functional configuration shown in FIG. 1. In the information display apparatus includes a display and operation unit 110, a controller 120, and an operation management unit 130.

The display and operation unit 110 includes a display unit 111, and a touch panel unit 112.

In addition, the operation managing unit 130, the operation panel display unit 131 includes a gesture detector 132, and an operation determination unit 133.

Hereinafter, the detailed operations of the information display device will be described with reference to the flowchart of FIG. 22. In the flowchart of FIG. 22, assuming that the operation panel is displayed on the information display apparatus.

(Step S2201) gesture detector 132, the touch panel unit 112, determines whether the received information indicating the touch position. Go to step S2202 if it has received the information indicating the touch position, and goes to step S2207 if it does not receive the information indicating the touch position. The information indicating the touch position may be any information indicating the position of the screen, usually a coordinate information, for example, information representing the relative position in the touched object and the object (for example, the coordinate values, ID of the mesh, etc.).

(Step S2202) gesture detector 132, information indicating the touch position acquired in step S2201, is temporarily stored in the property of the object of the work, not shown. Note that this storage is usually a postscript. Incidentally, the properties of the work object are an example of a region information indicating the touch position is stored, the information indicating the touch position may be stored in another area (a recording medium).

(Step S2203) gesture detector 132 uses the information indicating the one or two or more touch positions are set in the property of the object of the work, not shown, it determines the gesture. Gesture, for example, a ‘tap operation on the center button’, long-press operation on the center button′, ‘swipe operation to the jog dial’, ‘slide operation’, ‘pinch-operation’, ‘pinch-out operation’. Gesture detection unit 132, for example, has a state variable derived from the state transition diagram for recognizing these operations. Note that the information (typically, coordinate information) indicating a region of an object such as the center button or a jog dial, for example, are stored in the properties of the management object which manages objects (present in the storage unit, not shown). Note that the gesture detector 132, for example, an operation identifier which identifies the operation, are stored in pairs and condition using the information indicating the touch position information indicating the acquired one or more touch positions are matching condition It may be obtained the corresponding operation identifier. Moreover, since such a gesture determination technique is a known technique, a detailed description thereof will be omitted.

(Step S2204) operation determining unit 133, the gesture which is determined in step S2203 it is determined whether the tap operation to the center button. If an operation is detected as a tap operation on the center button go to step S2205, if it is not tap operation to the center button, go to step S2209 respectively.

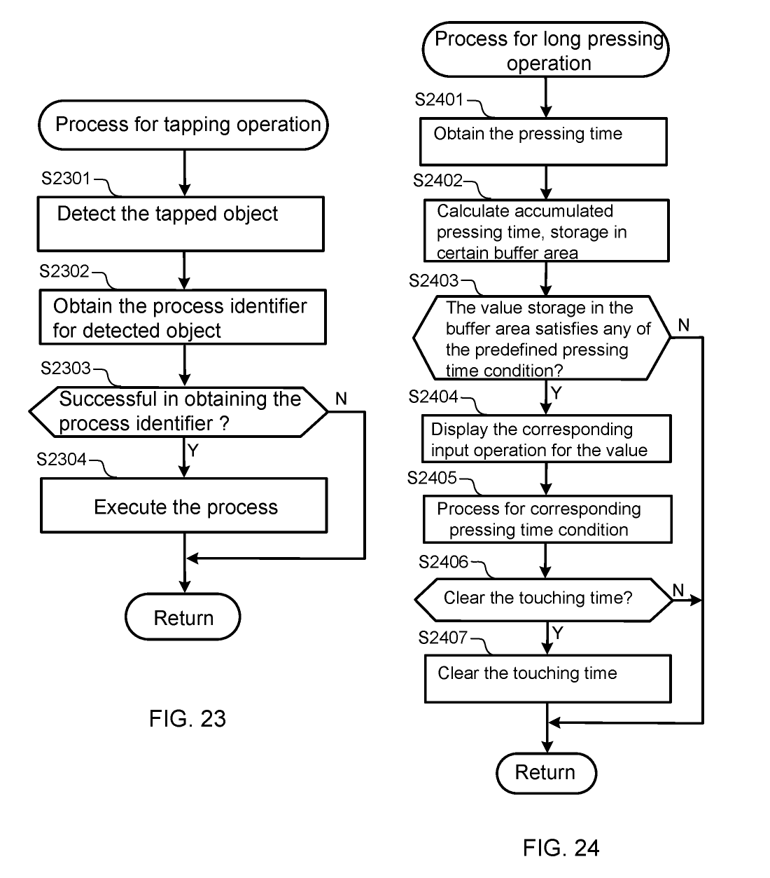

(Step S2205) Operation determining unit 133 performs a tap operation processing is a processing corresponding to the tap operation to the center button. The tap operation process will be described with reference to the flowchart of FIG. 23.

(Step S2206) Operation determining unit 133 clears the object properties of the workpiece (not shown). That is, the operation determination unit 133 initializes the information indicating the one or more touch positions are set to the object of the work, not shown by the value of null. It goes back to step S2201.

(Step S2207) Gesture detector 132 or the not-shown reception means, determines whether it has received any other input. Go to step S2208 if it has received the other input, if it does not accept other input then returns to step S2201.

(Step S2208) Operation managing unit 130 performs a process corresponding to the other input, goes back to step S2201.

(Step S2209) Operation determining unit 133, the gesture which is determined in step S2203 it is determined whether the press and hold operation on the center button. If long-press operation on the center button to go to step S2210, go to step S2211 if it is not long-press operation on the center button.

(Step S2210) Operation determining unit 133 performs the long press was operating process is a process corresponding to the long depression of the center button. It's going to step S2206. For long-press operation process will be described with reference to the flowchart of FIG. 24.

(Step S2211) Operation determining unit 133, the gesture which is determined in step S2203 it is determined whether a swipe operation on the jog dial. If it is determined as swipe operation of the jog dial, then goes to the step S2212, if it is not swipe operation of the jog dial go to step S2213.

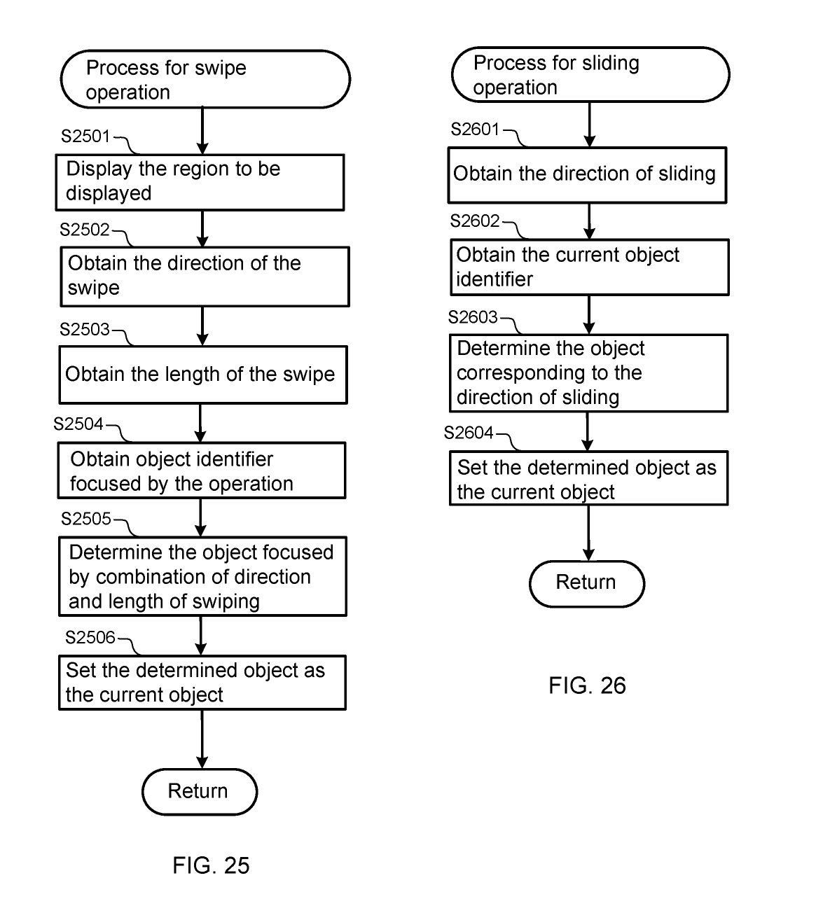

(Step S2212) Operation determining unit 133 performs a swipe operation processing corresponding to the swipe operation to the jog dial. It's going to step S2206. The swipe operation processing will be described with reference to the flowchart in FIG. 25.

(Step S2213) Operation determining unit 133, the gesture which is determined in step S2203 it is determined whether or not the sliding operation. If a slide operation, the procedure proceeds to step S2214, and proceeds to step S2215 and if the slide operation.

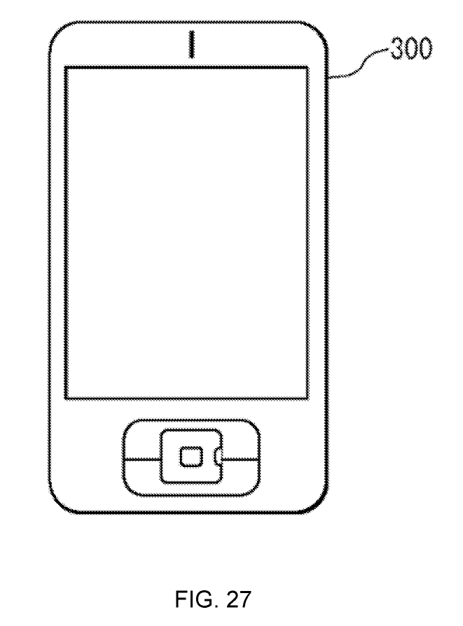

(Step S2214) Operation determining unit 133 performs the slide operation process is a process corresponding to the slide operation. It's going to step S2206. The slide operation process is described with reference to the flowchart in FIG. 26.

(Step S2215) Operation determining unit 133, the gesture which is determined in step S2203 it is determined whether or not the other predetermined operations. If other predetermined operation goes to step S2215, and if the other predetermined operation is returned to step S2201.

(Step S2216) Operation determining unit 133 performs a process corresponding to the other predetermined operations. It goes back to step S2201.

Next, an example of a tap operation process in step S2205, will be explained with reference to the flowchart in FIG. 23.

(Step S2301) Operation determining unit 133 now detects an object that is tapped. Incidentally, an object that is tapped, typically, is an object that currently has focus.

(Step S2302) Operation determining unit 133 acquires from the property of a work object (not shown) of the detected object in step S2301. Incidentally, usually, an object of the object is tapped from the information on the position of the tapped obtainable. Moreover, the operation determination unit 133 may retrieve the properties of a work object (not shown) the object being focused.

(Step S2303) Operation determining unit 133 determines whether or not acquired the object in step S2302. Go to step S2304 if it was possible to obtain an object, and returns to the upper-level processing If you are unable to retrieve the object. Note that the acquisition of the object may be acquired object identifier identifies the object.

(Step S2304) Operation determining unit 133 executes processing corresponding to the object acquired in step S2302. After this, it will return to the upper processing. Incidentally, for example, in association with processing of the processing to be executed when the object and the object is selected (when tapped) has been set in the storage portion (not shown), and is. Then, the operation determination unit 133, to get the process to become the object and the pair acquired in step S2302 from the storage unit. Next, the operation determination unit 133 executes the process. The execution of this process are, for example, jumping to a lower menu hierarchy, displaying of the fields of information corresponding to the item in focus, jumping to corresponding screen, and so on.

Next, an example of a long-press operation process in step S2210, will be explained with reference to the flowchart in FIG. 24.

(Step S2401) Operation determining unit 133 or gesture detection unit 132 uses the information indicating the one or more touch positions are set in the property of a work object (not shown), obtains the touch time.

(Step S2402) Operation determining unit 133 or gesture detector 132 uses the touch time acquired in step S2401, and calculates the cumulative touch time, accumulates the properties of the work object, not shown. Incidentally, accumulated touch time is set in the properties of a work object (not shown), the operation determining unit 133 or gesture detection unit 132, to the accumulated touch time is set in the properties of the work object obtained in step S2401 by adding it to touch time, and calculates the total touch time. Then, the operation determination unit 133 or gesture detection unit 132 overwrites the property of a work object (not shown) the calculated total touch time.

(Step S2403) Operation determining unit 133 determines if the accumulated touching time satisfies whether the predefined conditions. Go to step S2404 if the touching time satisfies certain condition, or returns to the upper process if it does not satisfy any of the conditions. Here, ‘the conditions’ means for example, a condition for changing the display of the cycle bar 213. Also the condition means for example, to change the display of the cycle bar 213, and is a condition for performing the above-described hierarchical switching control. The condition is a condition generally on the length of the accumulated touch time. Furthermore, typically, the properties of the work object, not shown, the processing for identifying a condition and processing has been set in advance.

(Step S2404) Operation determining unit 133 performs the display change corresponding to the conditions is met in step S2403 operation determining unit 133, for example, to correspond to the conditions met in step S2403, it changes the display of the cycle bar 213. This process has been described above with reference to such as FIG. 6.

(Step S2405) Operation determining unit 133 performs a process corresponding to the condition is met in step S2403. Such process is, for example, a hierarchical switching control.

(Step S2406) Operation determining unit 133 determines whether or not to clear the touch time of the storage unit. Go to step S2407 in case of clearing, or return to the upper-level processing if in case of not to clear. Note that for example, in association with the conditions, a flag indicating whether to clear the touch time or not has been managed.

(Step S2407) Operation determining unit 133 clears the touch time of the storage unit. It will return to the upper process.

Next, an example of a swipe operation process in step S2212, will be explained with reference to the flowchart in FIG. 25.

(Step S2501) Operation determining unit 133, the position corresponding to the most recent touch position, and displays the display area 214. Note that the display of the display area 214, the symbol indicating the display area 214 (for example, ellipse symbol 214 in FIG. 2) is displayed.

(Step S2502) Operation determining unit 133 uses the information of the two or more touch positions, it determines the direction of the swipe. The direction of the swipe is, for example, any of the information indicating the information indicating ‘clockwise’ or ‘counter-clockwise’.

(Step S2503) Operation determining unit 133, by using the difference of the start and end of the x-coordinate and y-coordinate of the swipe, calculates the amount of movement of the swipe.

(Step S2504) Operation determining unit 133 acquires an object which currently focused.

(Step S2505) Operation determining unit 133 determines the object to be focused by the direction determined in step S2502 and the amount of movement (i.e. the length of movement) calculated in step S2503, and obtained object in step S2504. Here, the candidate of the object to be focused is, for example, the item in the menu in the first embodiment, the tab constituting the UI in the second embodiment, any of the data (any of 00,15,30,45) in the third embodiment. In other words, a candidate of the object to be focused is, one of the ordered objects containing more than or equal to two items. Also, the operation determining unit 133 may determine the object to be focused only by the direction determined in step S2502 and obtained object in step 2504. That is, the operation determination unit 133 may determine the object to be focused without using the amount of movement. In such cases usually the movement of the focus is achieved by the one by one object movement

(Step S2506) Operation determining unit 133, the object determined in step S2505 as an object of the current, performs focusing process. The result will be returned to the upper processing. Here the process of focusing is, for example, a process to display menu item in focus to be displayed visually distinct from other items in other fields so as to the item is displayed prominently, and display the focused target value (eg, 00) on the target field, and so on.

Next, an example of a slide operation process in step S2214, will be explained with reference to the flowchart in FIG. 26.

(Step S2601) Operation determining unit 133 determines the direction of slide according to the difference of x-coordinates and y-coordinates between the touch start position and the touch end position, which had been already obtained by mouse events and set in the property of work object.

(Step S2602) Operation determining unit 133 obtains the object which is currently focused.

(Step S2603) Operation determining unit 133, with respect to the object obtained in step S2602, obtains the object located in the direction determined in step S2601. The position information (usually coordinate information) indicating the position of the object is usually set in the managed object table (not shown here) or managed object of JSON format.

(Step S2604) Operation determining unit 133, the object obtained in step S2603 as the current object, performs focusing process. The result will be returned to the upper process. Here, the focusing process is, for example, a process that allows input from an input device such as keyboards or software keyboards or bar code in the current entry field, the other buttons of the focus target button and visually distinctive manner.

As described above, in this embodiment, even if the number of items registered in the item list is very large, it can be performed in a short time to the selection operation of a desired item with simple operation.

Also in the above embodiment, it is possible to provide a very easy-to-use operation panel 210 by changing the composition of display in the panel so that the status of the operation panel 210 is visually recognizable. Note that the display changes in the operation panel 210, for example, movement of the display area 214, and an indication of change in the cycle bar 213.

Moreover, the position of the operation panel 210 on the display screen is customizable depending on the operator's dominant arm or preferences, and so on.

In addition, by changing the position of the operation panel 210 on the display screen automatically to a suitable position to be operated easily by a finger of the operator according to the contents of the screen of the operation target or by the tilting degree of the information display device, it realizes the suitable position for the operating and usage of the operation panel 210 so that the operation of the operation panel 210 becomes easy. The position of easy to operate with the fingers is not shown here, to be specified in the setting screen.

Here, the process in the above embodiment may be realized by software. And it is also possible to distribute this software by the software downloads or other distribution methods. This software may also be distributed in a recording medium such as CD-ROMs. Incidentally, this also applies to other embodiments described in this specification. In addition, the software that implements the information processing apparatus in this embodiment is the following program. In other words it is a program to functionalize it as operation judgment region to perform choice decision control to let choice for the candidate said choice settle when candidate reshuffling control to change the movement quantity of the above touch position and the above item where it is with candidate choice depending on a movement direction sequentially and the tap operation to an operation button of the above first were performed when this program is a program to accept the touch operation to an indication screen, and to realize a screen operation function to choose, for example, one either among the plural items, and the swipe operation to the gesture detecting element which at least detects swipe operation to move a touch position and an operation button of the above second is performed along tap operation to touch an operation button of the operation panel indication region and above first letting an above indication screen at least display an operation button of the abbreviation ring-shaped second to surround the circumference of the first operation button and the operation button of the said first with a computer and an operation button of the above second by rotatory direction.

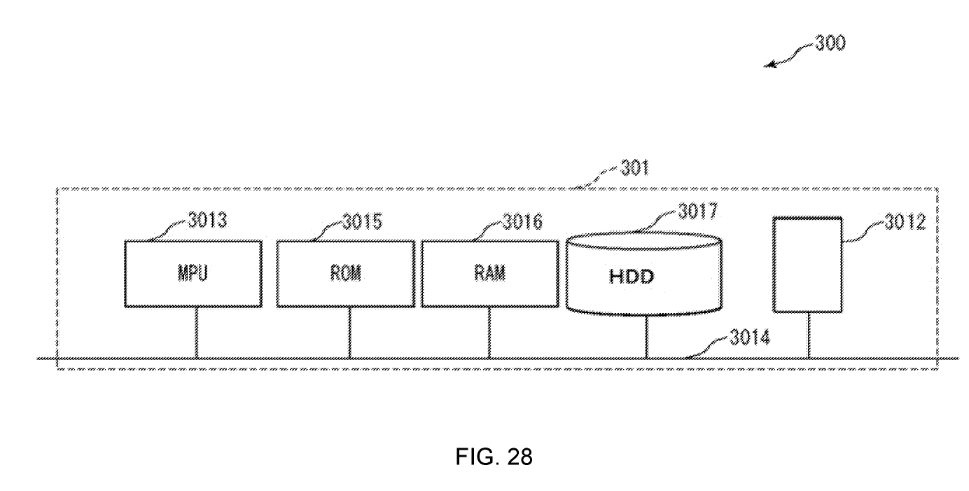

Referring now to FIGS. 27-28 in the drawings, overview diagrams of a computer system implementing the information display device 100 according to the first, the second, the third, the fourth and the fifth embodiments is illustrated.

FIG. 27 shows the external appearance of a computer which realizes the information display devices of various embodiments of the present application described above, by executing the programs described in this specification. FIG. 27 is for example, smart phone or a tablet terminal.

In addition, the above-described embodiments may be implemented by a computer hardware and computer software executed on it for example. FIG. 27 is the schematic view of a computer system 300, and FIG. 28 is the block diagram of a system 300.

In FIG. 28, the computer 301 contains a display 3012 with a touch panel, MPU 3013, bus 3014, ROM 3015 connected to ROM 3015 and MPU 3013 in order to memorize programs such as boot-up programs, RAM 3016 connected to MPU 3013 in order to memorize instructions of an application program temporary and providing a temporary storage space, and application program, a system program, and a hard disk 3017 in order to store the data. Here, although not shown, the computer 301 may contain a network card that provides the network connection to LAN.

In the computer system 300, a program for executing the function of the information display device of the embodiment described above is stored in the hard disk 3017. Here, it is already known how the computer system 300 works, therefore a detailed description is omitted.

The computer that executes this program may be single unit or consist of multiple units, i.e. both centralized processing and distributed processing are allowed.

And in the foregoing embodiments, each process (each function) may be realized by integrated process by a single device (system) or distributed process by multiple devices (systems).

The present invention is not limited to the above embodiments, but may be altered variously, and naturally these modifications are included within the scope of the present invention.

### DESCRIPTION OF THE CODES

100 tablet device
110 operation unit
111 display unit
112 touch panel unit
120 control unit
130 operation management section
131 operation panel display unit
132 gesture detection unit
133 operation determining unit
200 display screen
210,710,1020,1620 operation panel
211,711,1021,1621 center button
212,712,1022,1622 jog dial
213,713 cycle bar
220 roster
301 title
302 start button
700 display screen
701 position mark
720 customer information
1000 Calendar
1010 working hours input screen
1011 date
1012 attendance time entry field
1013 clock-out time entry field
1014 Cancel button
1015 send button
1023 display area
1600,1900 input screen
1611,1612,1613,1911,1912,1913 entry field
1630 cursor

The current application has many advantages over the prior art that have been described above. The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An information display device for realizing a screen operation function of selecting any one of a plurality of items, using a touch operation on a display screen, comprising:
an operation panel display unit that displays at least a first operation button, and a second operation button substantially in the shape of a ring surrounding an outer circumference of the first operation button, on the display screen;
a gesture detection unit that detects at least a tap operation of touching the first operation button and a swipe operation of moving a touch position in a rotational direction along the second operation button; and
an operation determination unit that performs candidate switching control for, when a swipe operation along the second operation button is being performed, sequentially switching the item to be a selection candidate in accordance with a movement amount and a movement direction of the touch position, and selection finalizing control for, when a tap operation on the first operation button is performed, finalizing the selection of the selection candidate.

2. The information display device according to claim 1, wherein an operation in which the candidate switching control is performed to decide on, as a selection candidate, any one of one or a plurality of items in a same level displayed on the display screen, after which the selection finalizing control is performed to finalize the selection of the selection candidate and to display one or a plurality of items in a lower level corresponding to the selected item, is repeated over two or more levels, so that any one item is selected from an item list having a hierarchical structure.

3. The information display device according to claim 2,
wherein the gesture detection unit detects a hold-down operation of touching the first operation button for a set period of time; and
wherein when the hold-down operation is performed on the first operation button, the operation determination unit performs level switching control for switching the item list displayed on the display screen from a current level to a level that is higher than the current level by a given number of levels.

4. The information display device according to claim 3, wherein the operation determination unit repeats the level switching control each time the execution time of the hold-down operation reaches an integral multiple of the set period of time.

5. The information display device according to claim 3,
wherein the operation panel display unit displays a cycle bar when the hold-down operation is being performed on the first operation button; and
wherein the cycle bar performs one rotation each time the time of the hold-down operation reaches the set period of time.

6. The information display device according to claim 2,
wherein the display screen displays a map and position marks; and
wherein when any one position mark is selected, one or a plurality of the items contained in the highest level in the item list corresponding to the position mark are displayed.

7. The information display device according to claim 1,
wherein the display screen displays a first input field to which any one of a plurality of items is selected and input; and
wherein the candidate switching control is performed to decide on any one of the plurality of items as a selection candidate for an item that is input to the first input field, and thereafter the selection finalizing control is performed to finalize the selection of the selection candidate.

8. The information display device according to claim 7, wherein the item that is input to the first input field is time data.

9. The information display device according to claim 1,
wherein the display screen simultaneously displays a plurality of second input fields;
wherein the gesture detection unit further detects a slide operation of, from a state of touching the first operation button, moving the touch position across a boundary between the first operation button and the second operation button; and
wherein when the slide operation is performed, the operation determination unit performs field switching control for switching selection of the second input field to which input is to be performed.

10. The information display device according to claim 9, wherein the operation determination unit decides on the second input field to be selected by the switching according to a movement direction of the touch position when the slide operation is being performed.

11. The information display device according to claim 1,
wherein the display screen includes a display region indicating a region designated by a designating member, inside a region of the second operation button; and
wherein when a swipe operation is being performed by moving the designating member, the operation determination unit performs control for performing display such that the display region moves inside the region of the second operation button following the movement of the designating member.

12. The information display device according to claim 11, wherein, in a state where the display region is not displayed, when a designation by the designating member is detected inside the region of the second operation button, the operation determination unit performs control for displaying the display region in a region including the region designated by the designating member.

13. The information display device according to claim 11, wherein in a state where the display region is displayed, when a designation by the designating member is detected in a region that is inside the region of the second operation button and in which the display region is not displayed, the operation determination unit performs control for displaying the display region in a region including the region designated by the designating member.

14. An information display method for realizing a screen operation function of selecting any one of a plurality of items, using a touch operation on a display screen, the method being realized with an operation panel display unit, a gesture detection unit, and an operation determination unit, the method comprising:
an operation panel display step of the operation panel display unit displaying at least a first operation button, and a second operation button substantially in the shape of a ring surrounding an outer circumference of the first operation button, on the display screen;
a gesture detection step of the gesture detection unit detecting at least a tap operation of touching the first operation button and a swipe operation of moving a touch position in a rotational direction along the second operation button; and
an operation determination step of the operation determination unit performing candidate switching control for, when a swipe operation along the second operation button is being performed, sequentially switching the item to be a selection candidate in accordance with a movement amount and a movement direction of the touch position, and selection finalizing control for, when a tap operation on the first operation button is performed, finalizing the selection of the selection candidate.

15. A storage medium in which a program for realizing a screen operation function of selecting any one of a plurality of items by accepting a touch operation on a display screen is stored, the program causing a computer to execute:
an operation panel display unit that displays at least a first operation button, and a second operation button substantially in the shape of a ring surrounding an outer circumference of the first operation button, on the display screen;
a gesture detection unit that detects at least a tap operation of touching the first operation button and a swipe operation of moving a touch position in a rotational direction along the second operation button; and
an operation determination unit that performs candidate switching control for, when a swipe operation along the second operation button is being performed, sequentially switching the item to be a selection candidate in accordance with a movement amount and a movement direction of the touch position, and selection finalizing control for, when a tap operation on the first operation button is performed, finalizing the selection of the selection candidate.
